(19) United States
(12) Patent Application Publication
(10) Pub. No.: US 2026/0008479 A1
(43) Pub. Date: Jan. 8, 2026

(54) METHOD AND APPARATUS FOR GENERATING TRAJECTORY, ELECTRONIC DEVICE, STORAGE MEDIUM

(71) Applicant: BEIJING CO WHEELS TECHNOLOGY CO., LTD., Beijing (CN)

(72) Inventors: Bailin LI, Beijing (CN); Kun ZHAN, Beijing (CN); Peng JIA, Beijing (CN); Xianpeng LANG, Beijing (CN); Yang WANG, Beijing (CN); Junru GU, Beijing (CN); Yue JIANG, Beijing (CN); Qi JIANG, Beijing (CN); Simeng ZHAO, Beijing (CN); Song CUI, Beijing (CN); Mingyu GUO, Beijing (CN); Jiaxin FAN, Beijing (CN); Dafeng WEI, Beijing (CN); Zhao YANG, Beijing (CN); Zijian WANG, Beijing (CN); Zhiyong ZHAO, Beijing (CN); Zhenyang WANG, Beijing (CN); Xu BIAN, Beijing (CN); Wei XIAO, Beijing (CN); Shiwei WANG, Beijing (CN); Tong WANG, Beijing (CN); Jinyuan FENG, Beijing (CN); Qin WANG, Beijing (CN); Hongkun CHEN, Beijing (CN); Pengfei JI, Beijing (CN); Jian ZHOU, Beijing (CN)

(21) Appl. No.: 19/037,583

(22) Filed: Jan. 27, 2025

(30) Foreign Application Priority Data
Jul. 4, 2024 (CN) 202410896803.3
Jul. 4, 2024 (CN) 202410897292.7
Jul. 4, 2024 (CN) 202410898347.6

(51) Int. Cl. B60W 60/00; G06V 20/56

(52) U.S. Cl. CPC B60W 60/001; G06V 20/56

(57) ABSTRACT

The present disclosure discloses a trajectory generation method, apparatus, electronic device, storage medium and program, wherein the method includes: acquiring driving-related data corresponding to a current vehicle; inputting first driving-related data in the driving-related data to a pre-created target trajectory generation model to obtain a candidate driving trajectory corresponding to the current vehicle; inputting second driving-related data in the driving-related data into a pre-created target driving correction model to obtain corresponding driving correction information; and correcting the candidate driving trajectory based on the driving correction information to obtain a corresponding target driving trajectory, such that the current vehicle automatically drives according to the target driving trajectory. The present disclosure corrects the candidate driving trajectory by the driving correction information to obtain the target driving trajectory, effectively avoiding the problem of poor correction effect caused by manual trajectory correction, and improving the accuracy and effectiveness of trajectory correction.

### CROSS-REFERENCE TO RELATED APPLICATIONS

The present disclosure claims priority to Chinese patents with application No. 202410896803.3, entitled “METHOD AND APPARATUS FOR GENERATING TRAJECTORY, ELECTRONIC DEVICE, STORAGE MEDIUM”, filed on Jul. 4, 2024, Application No. 202410897292.7, entitled “A DATA PROCESSING METHOD, APPARATUS, ELECTRONIC DEVICE, PROGRAM AND STORAGE MEDIUM”, filed on Jul. 4, 2024, and application No. 202410898347.6, entitled “METHOD AND APPARATUS FOR GENERATING TRAJECTORY, ELECTRONIC DEVICE, STORAGE MEDIUM”, filed on Jul. 4, 2024, to China National Intellectual Property Administration, the entire contents of which are incorporated herein by reference.

### TECHNICAL FIELD

The present disclosure relates to the technical field of intelligent driving, in particular to a method and apparatus for generating a trajectory, an electronic device, a medium.

### BACKGROUND

In the field of autonomous driving, the research on a trajectory generation technology occupies an increasingly high position. A driving trajectory of a vehicle within a certain period of time in the future can be predicted by the trajectory generation technology, which can not only avoid dangerous interactive behaviors, but also provide analysis assistance for a decision-making and planning system.

In the prior art, an end-to-end model may be used for trajectory correction, but cannot deal with complex driving scenes (e.g., cattle and sheep suddenly appear on a road, etc.). Therefore, how to deal with complex driving scenes and generate a trajectory is an urgent problem to be solved.

### SUMMARY

A method and apparatus for generating a trajectory, an electronic device, a storage medium and a program are intended to solve the technical problem that the prior art cannot generate trajectories for complex scenes.

According to an aspect of the present disclosure, a method for generating a trajectory is provided. The method includes:
acquiring driving-related data corresponding to a current vehicle;
inputting first driving-related data in the driving-related data into a pre-created target trajectory generation model to obtain a candidate driving trajectory corresponding to the current vehicle;
inputting second driving-related data in the driving-related data into a pre-created target driving correction model to obtain corresponding driving correction information; and
correcting the candidate driving trajectory based on the driving correction information to obtain a corresponding target driving trajectory.

According to another aspect of the present disclosure, a method for generating a trajectory is provided. This method is applied to a trajectory generation chip set, wherein the chip set at least includes a first chip and a second chip; and the method includes:
acquiring driving-related data corresponding to a current vehicle;
inputting second driving-related data in the driving-related data into a target driving correction model pre-created by the first chip to obtain corresponding driving correction information; and
inputting first driving-related data in the driving-related data into a target trajectory generation model pre-created by the second chip to obtain a candidate driving trajectory corresponding to the current vehicle; and correcting the candidate driving trajectory by the second chip based on the driving correction information to obtain a corresponding target driving trajectory.

According to another aspect of the present disclosure, an electronic device is provided. The electronic device includes:
at least one processor; and
a memory communicationally connected to the at least one processor, wherein
the memory is configured to store computer programs that can be executed by the at least one processor; and the computer programs, when executed by the at least one processor, enable the at least one processor to implement the method for generating the trajectory in any embodiments of the present disclosure.

According to another aspect of the present disclosure, a non-transitory computer-readable storage medium is provided. The non-transitory computer-readable storage medium is configured to store computer programs therein; and the computer programs are configured to, when executed by a processor, implement the method for generating the trajectory in any embodiment of the present disclosure.

According to the technical solutions in the embodiments of the present disclosure, the corresponding driving correction information is obtained by acquiring the second driving-related data and the first driving-related data of the current vehicle in the driving process, and inputting the first driving-related data into the target driving correction model pre-created by the first chip; the corresponding candidate driving trajectory is obtained by inputting the first driving-related data into the target trajectory generation model of the second chip; and the pre-generated candidate driving trajectory is automatically corrected by the second chip by the driving correction information to obtain the corresponding target driving trajectory. Therefore, the problem of poor correction effect caused by the use of manual correction for the driving trajectory in the prior art is effectively avoided, and the accuracy and effectiveness of driving trajectory correction are improved.

It should be understood that the content described in this section is not intended to limit the key features or important features in the embodiments in the present disclosure, nor is it intended to limit the scope of the present disclosure. The other features of the present disclosure are described below for easy understanding.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without paying creative efforts, in which:

FIG. 1 is a flowchart of a method for generating a trajectory provided by an embodiment of the present disclosure;

FIG. 2 is a flowchart of a method for training a target trajectory generation model provided by an embodiment of the present disclosure;

FIG. 3 is a flowchart of another method for generating a trajectory provided by an embodiment of the present disclosure;

FIG. 4 is a flowchart of yet another method for generating a trajectory provided by an embodiment of the present disclosure;

FIG. 5 is a flowchart of training of a target driving correction model provided by an embodiment of the present disclosure;

FIG. 6 is a schematic diagram of implementation of information correction provided by an embodiment of the present disclosure;

FIG. 7 is a flowchart of implementation of temporal fusion provided by an embodiment of the present disclosure;

FIG. 8 is a schematic structural diagram of an apparatus for generating a trajectory provided by an embodiment of the present disclosure;

FIG. 9 is a flowchart of a method for generating a trajectory provided by an embodiment of the present disclosure;

FIG. 10 is a flowchart of another method for generating a trajectory provided by an embodiment of the present disclosure;

FIG. 11 is a flowchart of another method for generating a trajectory provided by an embodiment of the present disclosure;

FIG. 12 is a schematic structural diagram of a target driving correction model provided by an embodiment of the present disclosure;

FIG. 13 is an exemplary flowchart of a method for correcting a target driving correction model provided by an embodiment of the present disclosure;

FIG. 14 is an exemplary diagram of squeeze and excitation processing provided by an embodiment of the present disclosure;

FIG. 15 is an exemplary diagram of a Spec-decode head provided by an embodiment of the present disclosure;

FIG. 16 is an exemplary diagram of saving candidate items in a speculative sampling process provided by an embodiment of the present disclosure;

FIG. 17 is a schematic structural diagram of an apparatus for generating a trajectory provided by an embodiment of the present disclosure; and

FIG. 18 is a schematic structural diagram of an electronic device for implementing a method for generating a trajectory provided by an embodiment of the present disclosure.

### DETAILED DESCRIPTION

In order for those skilled in the art to understand the solutions of the present disclosure better, the technical solutions in the embodiments of the present disclosure will be described clearly and completely in conjunction with the accompanying drawings in the embodiments of the present disclosure. Apparently, the described embodiments are merely some embodiments, rather than all embodiments, of the present disclosure. Based on the embodiments of the present disclosure, all other embodiments derived by a person of ordinary skill in the art without creative efforts shall fall within the protection scope of the present disclosure.

It should be noted that the terms “first”, “second” and the like in the description and claims, and the above-mentioned drawings, of the present disclosure are used to distinguish similar objects, but not necessarily used to describe a specific order or precedence order. It should be understood that data used in this way may be interchanged where appropriate so that the embodiments of the present disclosure described herein can be implemented in a sequence other than those illustrated or described herein. In addition, the terms “including” and “having” and any variations thereof are intended to cover non-exclusive inclusions, e.g., processes, methods, systems, products or devices containing a series of steps or units need not be limited to those steps or units that are clearly listed, but may include other steps or units that are not clearly listed or are inherent to those processes, methods, products or devices.

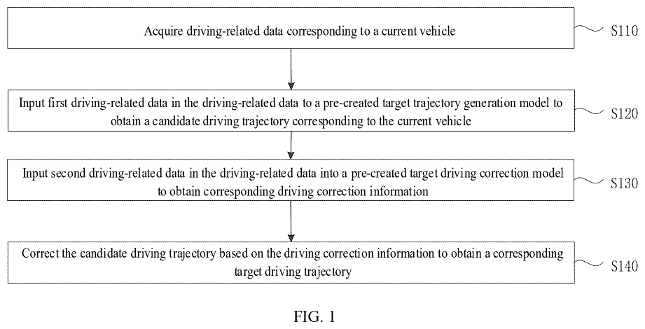

In one embodiment, FIG. 1 is a flowchart of a method for generating a trajectory provided by an embodiment of the present disclosure. This embodiment may be applicable to a situation where a driving trajectory in a complex driving scene is generated under an autonomous driving scene and the driving trajectory is automatically corrected. This method may be executed by an apparatus for generating a trajectory. A fault diagnosis apparatus may be implemented in a form of hardware and/or software. This apparatus for generating the trajectory may be configured in a vehicle end. As shown in FIG. 1, the method includes the following steps.

At S110, driving-related data corresponding to a current vehicle is acquired.

The driving-related data is used to represent various information which are generated or collected by the current vehicle in the process of automatic driving and can represent surrounding environment conditions of the vehicle, and an own state and driving operations of the vehicle. In one embodiment, the driving-related data includes first driving-related data and second driving-related data.

The first driving-related data may include sensor information, navigation planning information, and/or driving rule information. The sensor information includes environment perception information and/or state information. The environment perception information includes current frame data and/or current point cloud data. The state information includes position information of the current vehicle and/or attitude information of the current vehicle. The position information of the current vehicle may be position information collected by a GPS deployed inside the current vehicle. The attitude information of the current vehicle may include an orientation, a pitch angle, an accelerator pedal opening, gear information and the like of the current vehicle. The navigation planning information may be navigation planning information (navigation data from a position of the current vehicle to a destination, or navigation data from a preset distance to the destination before the position of the current vehicle) obtained by intercepting navigation data (total navigation data from a starting point to a destination) according to the position information of the current vehicle. The driving rule information may include traffic rule information and/or speed limit information. The speed limit information may be speed limit, acceleration, deceleration and other information. The traffic rule information is used to determine whether a driving behavior is in accordance with traffic rules, for example, bus lanes are not accessible, school sections require speed limits, etc.

In one example, the second driving-related data includes environment perception information, navigation planning information, and driving prompt information. The environment perception information refers to information which is collected by the current vehicle in the automatic driving process and can represent surrounding environment conditions of the vehicle. In this embodiment, various sensors (e.g., a camera, a millimeter-wave radar and a lidar) in the vehicle may be used to acquire information about a surrounding environment, including: road conditions, obstacles, other vehicles, pedestrians, and weather conditions. The road conditions may include road types, lane lines, traffic signs, and marked lines. The obstacles may include obstacle types, obstacle positions, obstacle shapes, obstacle speeds, etc. Other vehicles may include positions, speeds and driving directions of other vehicles, etc. The pedestrians may include positions and travel directions of the pedestrians, etc. The weather conditions may include: rain, snow, and fog, etc. The navigation planning information refers to a real-time geographic position, map data and path planning information of the current vehicle. The real-time geographic position may be obtained by GPS or other positioning systems. The map data may include relevant data of a high-precision map. The path planning information refers to relevant data and description of an optimal or preferred driving route from the starting position to the destination position of the vehicle, for example, may include: geometrical shapes of a driving trajectory (e.g., curves, slopes and straight sections), road nodes and road sections (intersections and highway entrances and exits), prediction information of traffic conditions (e.g., traffic congestion, construction areas and accidents), obstacle avoidance strategies and speed limits. The driving prompt information refers to a description of the current driving environment of the vehicle, and identification and other information of key objects, which are used to guide a target driving correction model to perform specific descriptions or prompts for thinking and inference. The current driving environment may include road conditions and weather conditions, and key objects may include obstacles.

In this embodiment, a prompt information library of an intelligent driving system may be pre-created, and corresponding driving prompt information may be acquired from this prompt information library according to the environment perception information of the current vehicle.

At S120, the first driving-related data in the driving-related data is input to a pre-created target trajectory generation model to obtain a candidate driving trajectory corresponding to the current vehicle.

The candidate driving trajectory is a predicted trajectory within a period of time in the future. For example, the candidate driving trajectory may be a predicted trajectory within the next 8 seconds.

It should be noted that the target trajectory generation model is obtained by continuous and iterative training based on the pre-trained initial trajectory generation model.

The target trajectory generation model may include a target backbone network, a target encoder, and a target decoder. The target trajectory generation model may also include a target backbone network, a target encoder, a target decoder and a target memory module, wherein the target memory module is used to store historical features.

Specifically, the target trajectory generation model includes a target backbone network, a target encoder and a target decoder; and the inputting the first driving-related data in the driving-related data into the pre-created target trajectory generation model to obtain the candidate driving trajectory corresponding to the current vehicle includes:
inputting the first driving-related data into the target backbone network to obtain a target fusion features;
inputting the first driving-related data into the target encoder to obtain a target encoding features; and
inputting the target fusion features and the target encoding features into the target decoder to obtain the candidate driving trajectory corresponding to the current vehicle.

Specifically, the target trajectory generation model includes a target backbone network, a target encoder, a target decoder and a target memory module; and the inputting the first driving-related data in the driving-related data into the pre-created target trajectory generation model to obtain the candidate driving trajectory corresponding to the current vehicle includes:
inputting the first driving-related data into the target backbone network to obtain a target fusion features;
inputting the first driving-related data into the target encoder to obtain a target encoding features; and
inputting the target fusion features, the historical features output by the target memory module and the target encoding features into the target decoder to obtain the candidate driving trajectory corresponding to the current vehicle.

It should be noted that, the first driving-related data includes sensor information and navigation planning information; the sensor information includes environment perception information and state information; the target trajectory generation model includes a target backbone network, a target encoder and a target decoder; and the inputting the first driving-related data in the driving-related data into the pre-created target trajectory generation model to obtain the candidate driving trajectory corresponding to the current vehicle includes:
inputting the environment perception information into the target backbone network to obtain a target fusion features;
inputting the state information and the navigation planning information into the target encoder to obtain a target encoding features; and
inputting the target encoding features and the target fusion features into the target decoder to obtain the candidate driving trajectory corresponding to the current vehicle.

It should be noted that, the first driving-related data includes sensor information and navigation planning information; the sensor information includes environment perception information and state information; the target trajectory generation model includes a target backbone network, a target encoder, a target decoder and a target memory module; and the inputting the first driving-related data in the driving-related data into the pre-created target trajectory generation model to obtain the candidate driving trajectory corresponding to the current vehicle includes:
inputting the environment perception information into the target backbone network to obtain a target fusion features;
inputting the state information and the navigation planning information into the target encoder to obtain a target encoding features; and
inputting the target fusion features, the historical features output by the target memory module and the target fusion features into the target decoder to obtain the candidate driving trajectory corresponding to the current vehicle.

It should be noted that, the first driving-related data includes sensor information, driving rule information and navigation planning information; the sensor information includes environment perception information and state information; the target trajectory generation model includes a target backbone network, a target encoder and a target decoder; and the inputting the first driving-related data in the driving-related data into the pre-created target trajectory generation model to obtain the candidate driving trajectory corresponding to the current vehicle includes:
inputting the environment perception information into the target backbone network to obtain a target fusion features;
inputting the state information, the driving rule information and the navigation planning information into the target encoder to obtain a target encoding features; and
inputting the target encoding features and the target fusion features into the target decoder to obtain the candidate driving trajectory corresponding to the current vehicle.

It should be noted that, the first driving-related data includes sensor information, driving rule information and navigation planning information; the sensor information includes environment perception information and state information; the target trajectory generation model includes a target backbone network, a target encoder, a target decoder and a target memory module; and the inputting the first driving-related data in the driving-related data into the pre-created target trajectory generation model to obtain the candidate driving trajectory corresponding to the current vehicle includes:
inputting the environment perception information into the target backbone network to obtain a target fusion features;
inputting the state information, the driving rule information and the navigation planning information into the target encoder to obtain a target encoding features; and
inputting the target fusion features, historical features output by the target memory module and the target encoding features into the target decoder to obtain the candidate driving trajectory corresponding to the current vehicle.

In the technical solution of this embodiment, the candidate driving trajectory corresponding to the current vehicle is obtained by inputting the first driving-related data of the current vehicle into the target trajectory generation model. The information loss can be reduced, which in turn improves the accuracy of the predicted trajectory. Based on the candidate driving trajectory output by the target trajectory generation model, the vehicle can be controlled in parallel in transverse and longitudinal directions, instead of serial control. That is, the left and right control and the front and rear control are not separated, so that the vehicle can merge lanes or bypass obstacles more smoothly in the driving process.

Optionally, the inputting the driving-related data into the target trajectory generation model to obtain the candidate driving trajectory corresponding to the current vehicle includes:
inputting the driving-related data into the target trajectory generation model to obtain the candidate driving trajectory corresponding to the current vehicle, obstacle information and a road structure.

It should be noted that, in addition to the candidate driving trajectory, the output of the target trajectory generation model also includes the obstacle information and the road structure, and the road structure may be lane lines. The obstacle information and the road structure are used to aid in the display of obstacles, in order to remind a driver of positions of obstacles, further avoid collisions with obstacles and improve the driving safety.

In this embodiment of the present disclosure, the target trajectory generation model may output a plurality of trajectories, verify the plurality of trajectories by means of post-processing, and determine the trajectory that has passed the verification as the candidate driving trajectory.

Optionally, the obstacle information includes first-type obstacle information and second-type obstacle information.

The first-type obstacle information may be information on obstacles having fixed shapes. For example, the obstacles having fixed shapes may be pedestrians, bicycles, sedans, etc. The second-type obstacle information may be information on obstacles having non-fixed shapes. For example, the obstacles having non-fixed shapes may be excavators, fences, cranes, street lights, etc. The second-type obstacle information may be occupancy network (OCC) information. It can accurately identify and segment obstacles in complex road environments, thereby improving the safety and flexibility of the intelligent driving system. The OCC information may be a three-dimensional occupancy grid that represents a spatial distribution of obstacles in an image.

In a specific example, frame data collected by a camera and point cloud data collected by lidar are input into the target backbone network; features of a plurality of sensors are extracted and fused, and projected into a BEV space; the state information and the navigation planning information are input into the target encoder; and after encoding of a transformer, the first-type obstacle information, the second-type obstacle information and the road structure are decoded together with the BEV features, and the candidate driving trajectory is planned. In summary, the embodiment of the present disclosure realizes multi-task output by an integrated model. Therefore, the target trajectory generation model provided by this embodiment of the present disclosure is different from other multi-stage or integrated models in the prior art.

At S130, second driving-related data in the driving-related data is input into a pre-created target driving correction model to obtain corresponding driving correction information.

The driving correction information includes at least one of the followings: a driving reference position, a driving scene, and driving operation correction information. The driving reference position may also be referred to as a horizontal and longitudinal trajectory reference signal, which refers to a plurality of reference points in the predicted driving trajectory of the current vehicle. In this embodiment, the predicted driving trajectory of the current vehicle can be given by driving through the reference points. For example, if the driving operation correction information is given as detour, a driving trajectory of the detour may be split into a plurality of key points, followed by automatic driving according to the driving trajectory composed of the plurality of key points. The driving scene refers to types of roads on which the vehicle is currently driving, such as a viaduct, a slope, and main and auxiliary roads. The driving operation correction information refers to recommended information on the driving operations of the current vehicle. For example, the driving operations (also known as macro driving decision information) may include, but are not limited to: longitudinal driving and transverse driving. The longitudinal driving may include acceleration, deceleration and other operations. The transverse driving may include turning, changing lanes, turning to the left and right and other operations. The target driving correction model is a model that generates driving correction information based on the second driving-related data of the current vehicle to dynamically adjust the driving operations of the current vehicle. Illustratively, the target driving correction model may be visual language model (VLM).

An overall process of VLM may include scene description, scene analysis, and hierarchical planning, and deal with complex traffic scenes by the following key steps. The scene description refers that the system first uses a language to describe a driving environment and identify key objects, including environment descriptions such as weather, time, road types, and lane conditions, and the identification of key objects in the current scene that may affect driving behaviors. The scene analysis is the further analysis of the features of key objects, including static attributes, motion states, and specific behaviors, to predict potential impacts of these objects on the ego vehicle. The hierarchical planning generates a driving plan in combination with scene-level summaries, and routes, attitudes and speeds of the ego vehicle. This includes meta-actions, decision description, and trajectory waypoints. The meta-actions represent short-term driving strategies such as acceleration, deceleration, turning, etc. The decision description is a detailed description of a more detailed driving strategy that should be taken by the ego vehicle, including actions, a theme, and a duration. The trajectory waypoints are generated based on the decision description. These waypoints depict a path of the ego vehicle within a period of time in the future.

Specifically, the used VLM includes a Chain-of-Thought (CoT) process with three key modules: scene description, scene analysis, and hierarchical planning. A scene description module describes a driving environment linguistically and identifies key objects in the scene. A scene analysis module delves into features of the key objects and their impacts on an ego carrier. A hierarchical planning module develops a plan step by step, from the meta-actions and the decision description to the waypoints.

The visual language model (VLM) processes a series of images to perform special CoT inference so as to derive a driving planning result. An architecture of the VLM used herein includes a visual converter encoder and a large language model (LLM). The visual encoder generates image tokens. Then, an attention-based extractor aligns these labels with the LLM. The inference process may be divided into three modules: scene description, scene analysis, and hierarchical planning.

In order to solve the limitations of VLM in spatial inference and computational requirements, the following two strategies are adopted to improve the performances. Integrated 3D perception: object information detected by a 3D detector is used to assist in a language model, thereby improving understanding of key object positions and motion. High-frequency trajectory refinement: real-time planning and optimization of a high-frequency trajectory can be realized in combination with the traditional planner. Through these steps, it is possible to understand and predict complex traffic scenes and generate appropriate driving decisions and trajectory planning so as to cope with unpredictable and dynamically changing driving environments.

In this embodiment, the second driving-related data of the current vehicle is input into the target driving correction model to obtain recommended information on whether acceleration, deceleration and steering operations are required, which is then used as driving correction information.

At S140, the candidate driving trajectory is corrected based on the driving correction information to obtain a corresponding target driving trajectory.

In this embodiment, the driving correction information is input into the pre-created target trajectory generation model, such that the target trajectory generation model corrects the candidate driving trajectory based on the driving correction information to obtain the corresponding target driving trajectory, and the current vehicle automatically drives according to the target driving trajectory.

In one example, part of the driving correction information may be input into the target trajectory generation model. For example, macro driving decision information (e.g., transverse lane changes including detours and turns; and longitudinal lane changes including setting speeds, acceleration and deceleration), parking and waiting position points, features vectors for driving decision encoding, encoding complex driving decision content, and horizontal and longitudinal trajectory reference information (the transverse trajectory reference information is mainly reference driving path sampling points, and the longitudinal trajectory reference information is mainly a target velocity and other information of each of the sampling points) may be input into the target trajectory generation model, such that the target trajectory generation model corrects the candidate driving trajectory based on the driving correction information to obtain the corresponding target driving trajectory.

In one example, the correction process includes three implementations. In addition, these three implementations are becoming more and more deeply combined. In the first implementation, the target driving correction model outputs some macroscopic and long-term driving decision suggestions (e.g., transverse and longitudinal), and directly takes the driving decision suggestions as input data and inputs them to the target trajectory generation model, so as to ensure that the driving trajectory output by the target trajectory generation model is more in line with more macro suggestions, thereby generating a target driving trajectory that conforms to the macro driving decision. In the second implementation, the target driving correction model outputs some macroscopic and long-term driving decision suggestions (e.g., transverse and longitudinal), presents the driving decision suggestions (i.e., encoding of features vectors for the driving decision suggestions) in the form of features vectors, and inputs the encoded features vectors into the target trajectory generation model as input data, so as to ensure that the target trajectory generation model outputs more correct driving decisions and driving trajectories. In the third implementation, by selecting, through a learned model router, whether the corresponding target driving trajectory is output by the target trajectory generation model or the target driving correction model, the target trajectory generation model can be directly used under complex scenes to output more accurate driving decisions and driving trajectories, that is, the driving correction information can be directly used as the corresponding target driving trajectory, thereby avoiding the deviations of the driving decision and driving trajectory output by the target driving correction model.

In one example, the target trajectory generation model is a high-frequency system (e.g., runs at a frequency between 30 Hz and 100 Hz) and continuously outputs candidate driving trajectories. The target driving correction model is a low-frequency system (i.e., two inferences per one or two seconds).

According to the technical solution in this embodiment, the corresponding driving correction information is obtained by acquiring the first driving-related data and the second driving-related data of the current vehicle in the driving process, and inputting the first driving-related data into the pre-created target driving correction model; the corresponding candidate driving trajectory is obtained by inputting the second driving-related data into the target trajectory generation model; and the pre-generated candidate driving trajectory is automatically corrected by the driving correction information to obtain the corresponding target driving trajectory. Therefore, the problem of poor correction effect caused by manually set rule-based trajectory optimization strategies in the prior art is effectively avoided, and the accuracy and effectiveness of the correction for driving trajectories in complex driving scenes are effectively improved.

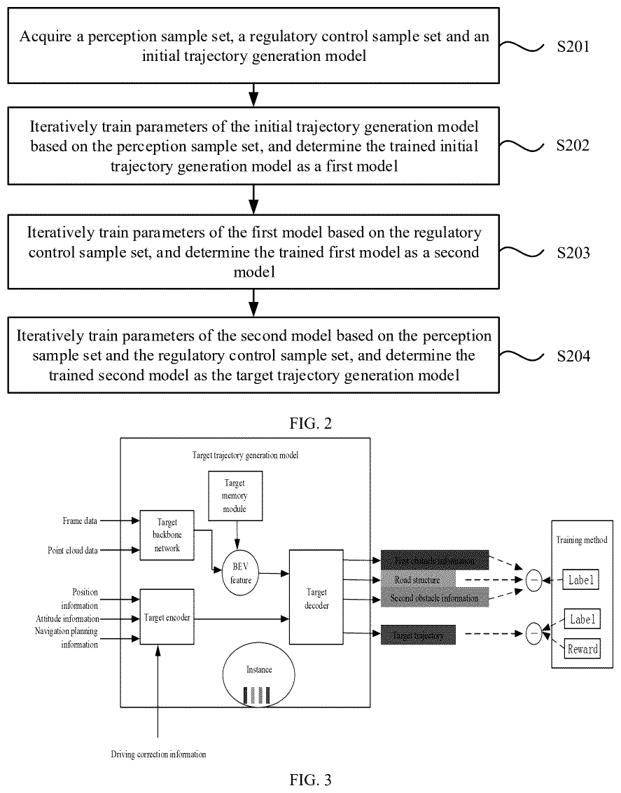

In one embodiment, FIG. 2 is a flowchart of a method for training a target trajectory generation model provided by an embodiment of the present disclosure. This embodiment is optimized on the basis of the above embodiment. In this embodiment, the method for training the target trajectory generation model includes: acquiring a perception sample set, a regulatory control sample set and an initial trajectory generation model; iteratively training parameters of the initial trajectory generation model based on the perception sample set, and determining the trained initial trajectory generation model as a first model; iteratively training parameters of the first model based on the regulatory control sample set, and determining the trained first model as a second model; and iteratively training parameters of the second model based on the perception sample set and the regulatory control sample set, and determining the trained second model as the target trajectory generation model. As shown in FIG. 2, the method specifically includes the following steps.

At S201, the perception sample set, the regulatory control sample set and the initial trajectory generation model are acquired.

The perception sample set may include a plurality of driving-related samples with labels. For example, the perception sample set may include a plurality of driving-related samples, and an obstacle label and a road structure label carried by each driving-related sample, and the road structure label may be a lane line label. The perception sample set may also include a plurality of driving-related samples with labels, and a plurality of driving-related samples without labels, and obstacle labels and road structure labels carried by the plurality of driving-related samples with labels. It should be noted that, if the perception sample set includes a plurality of driving-related samples with labels, and a plurality of driving-related samples without label, the training of the initial trajectory generation model may be divided into two stages. In the first stage, the initial trajectory generation model may be trained based on the plurality of driving-related samples with labels by a supervised learning method. In the second stage, the training is performed based on the plurality of driving-related samples without labels by a reinforced learning method. The training method of supervised learning followed by reinforced learning can improve the effect. In addition, the generation efficiency of the perception sample set can also be improved because some driving-related samples do not need to carry labels. It should be noted that by the reinforced learning method, the training method based on the plurality of driving-related samples without labels may be implemented by using the existing reinforced learning method, which will not be repeated here.

Since different drivers have different driving styles, even if the same driver has different driving styles at different driving times, it is also necessary to learn the input-output causality while learning the input-output correlation. In this embodiment of the present disclosure, by using supervised learning for training in the early stage and reinforced learning for training in the later stage, the learning of causality can be enhanced, and then the prediction trajectory can be more in line with the driver's driving styles.

The obstacle labels may include first-type obstacle labels and second-type obstacle labels.

The regulatory control sample set may include a plurality of driving-related samples with labels. For example, the regulatory control sample set may be a plurality of driving-related samples and a trajectory corresponding to each driving-related sample at the next moment. The regulatory control sample set may also include a plurality of driving-related samples with labels, and a plurality of driving-related samples without labels. It should be noted that the regulatory control sample set may include a plurality of driving-related samples with labels, and a plurality of driving-related samples without labels. The training of the first model may be divided into two stages. In the first stage, the first model may be trained based on the plurality of driving-related samples with labels by a supervised learning method. In the second stage, the training is performed based on the plurality of driving-related samples without labels by a reinforced learning method. The training method of supervised learning followed by reinforced learning can improve the effect. In addition, the generation efficiency of the perception sample set can also be improved because some driving-related samples do not need to carry labels. It should be noted that by the reinforced learning method, the training method based on the plurality of driving-related samples without labels may be implemented by using the existing reinforced learning method, which will not be repeated here. It should be noted that the reinforced learning method provided in this embodiment of the present disclosure is a reinforced learning method performed by means of contrast. Reinforced learning is performed by interaction.

The initial trajectory generation model may include an initial backbone network, an initial encoder, an initial decoder and a target memory module. The initial trajectory generation model may also include an initial backbone network, an initial encoder, and an initial decoder.

Specifically, the method of acquiring the perception sample set, the regulatory control sample set and the initial trajectory generation model may include: acquiring historical driving-related data; and generating a plurality of driving-related samples according to the historical driving-related data. The plurality of driving-related samples are labeled, wherein the perception sample set is generated according to the driving-related samples that have been added with the obstacle labels and road structure labels. The regulatory control sample set is generated based on the driving-related samples of the trajectory at the next moment. An initial trajectory generation model is created.

At S202, parameters of the initial trajectory generation model are iteratively trained based on the perception sample set, and the trained initial trajectory generation model is determined as the first model.

The parameters of the initial trajectory generation model include parameters of the initial backbone network, parameters of the initial encoder, and parameters of the initial decoder. The perception sample set includes a plurality of driving-related samples, and an obstacle label and a road structure label carried by each driving-related sample.

Specifically, the method of iteratively training the parameters of the initial trajectory generation model based on the perception sample set and determining the trained initial trajectory generation model as the first model may include: inputting the driving-related samples in the perception sample set into the initial trajectory generation model to obtain first predicted obstacle information and a first predicted road structure; and training parameters of the initial trajectory generation model according to a difference between the first predicted obstacle information and the obstacle label, and a difference between the first predicted road structure and the road structure label, and determining the trained initial trajectory generation model as the first model. The method of iteratively training the parameters of the initial trajectory generation model based on the perception sample set and determining the trained initial trajectory generation model as the first model may further include: inputting the driving-related samples in the perception sample set into the initial trajectory generation model to obtain first predicted obstacle information and a first predicted road structure; and training parameters of the initial trajectory generation model according to a difference between the first predicted obstacle information and the obstacle label, and a difference between a first predicted lane line and a lane line label, and determining the trained initial trajectory generation model as the first model.

Optionally, the perception sample set includes a plurality of driving-related samples, and an obstacle label and a road structure label carried by each driving-related sample.

The iteratively training the parameters of the initial trajectory generation model based on the perception sample set, and determining the trained initial trajectory generation model as the first model include:

inputting the driving-related samples in the perception sample set into the initial trajectory generation model to obtain first predicted obstacle information and a first predicted road structure; and

training parameters of the initial trajectory generation model according to a difference between the first predicted obstacle information and the obstacle label, and a difference between the first predicted road structure and the road structure label, and determining the trained initial trajectory generation model as the first model.

It should be noted that, when the initial trajectory generation model is trained, the initial trajectory generation model is only trained based on the obstacle information and the road structure. A weight of a loss function corresponding to the predicted trajectory is set to zero.

Specifically, the initial trajectory generation model includes an initial backbone network, an initial encoder and an initial decoder. The driving-related samples include sensor samples and navigation planning samples. The sensor data samples include environment perception samples and state samples. The inputting the driving-related samples in the perception sample set into the initial trajectory generation model to obtain the first predicted obstacle information and the first predicted road structure may include: inputting the environment perception samples into the initial backbone network to obtain first fusion features; inputting the state samples and the navigation planning samples into the initial encoder to obtain a first encoding features; and inputting the first encoding features and the first fusion features into the initialized initial decoder to obtain the first predicted obstacle information and the first predicted road structure.

The initial trajectory generation model includes an initial backbone network, an initial encoder and an initial decoder. The driving-related samples include sensor samples. The sensor data samples include environment perception samples and state samples. The method of inputting the driving-related samples in the perception sample set into the initial trajectory generation model to obtain the first predicted obstacle information and the first predicted road structure may include: inputting the environment perception samples into the initial backbone network to obtain first fusion features; inputting the state samples into the initial encoder to obtain a first encoding features; and inputting the first encoding features and the first fusion features into the initialized initial decoder to obtain the first predicted obstacle information and the first predicted road structure.

The initial trajectory generation model includes an initial backbone network, an initial encoder, an initial decoder and a target memory module. The driving-related samples include sensor samples and navigation planning samples. The sensor data samples include environment perception samples and state samples. The inputting the driving-related samples in the perception sample set into the initial trajectory generation model to obtain the first predicted obstacle information and the first predicted road structure may include: inputting the environment perception samples into the initial backbone network to obtain first fusion features; determining a second fusion features according to the first fusion features and historical features output by the target memory module; inputting the state samples and the navigation planning samples into the initial encoder to obtain a first encoding features; and inputting the first encoding features and the first fusion features into the initialized initial decoder to obtain the first predicted obstacle information and the first predicted road structure.

The initial trajectory generation model includes an initial backbone network, an initial encoder, an initial decoder and a target memory module. The driving-related samples include sensor samples. The sensor data samples include environment perception samples and state samples. The inputting the driving-related samples in the perception sample set into the initial trajectory generation model to obtain the first predicted obstacle information and the first predicted road structure may include: inputting the environment perception samples into the initial backbone network to obtain first fusion features; determining a second fusion features according to the first fusion features and the historical features output by the target memory module; inputting the state samples into the initial encoder to obtain a first encoding features; and inputting the first encoding features and the first fusion features into the initialized initial decoder to obtain the first predicted obstacle information and the first predicted road structure.

Specifically, the method of training the parameters of the initial trajectory generation model according to the difference between the first predicted obstacle information and the obstacle label, and the difference between the first predicted road structure and the road structure label may include: training the parameters of the initial trajectory generation module based on a first loss function, the difference between the first predicted obstacle information and the obstacle label, and the difference between the first predicted road structure and the road structure label. The first loss function may be a loss function in the prior art, which will not be limited in the embodiments of the present disclosure.

Optionally, the initial trajectory generation model may include an initial backbone network, an initial encoder, an initial decoder and a target memory module.

The inputting the driving-related samples in the perception sample set into the initial trajectory generation model to obtain the first predicted obstacle information and the first predicted road structure includes:
initializing the initial decoder based on a preset instance;
inputting the environment perception samples into the initial backbone network to obtain the first fusion features, and projecting the first fusion features into a BEV space;
determining first BEV features according to the first fusion features projected into the BEV space and BEV features output by the target memory module, and updating the BEV features stored in the target memory module according to the first BEV features;
inputting the state samples and the navigation planning samples into the initial encoder to obtain the first encoding features; and
inputting the first encoding features and the first BEV features into the initialized initial decoder to obtain the first predicted obstacle information and the first predicted road structure.

The initial decoder is initialized based on a preset instance. For example, if the obstacle information, the road structure and the trajectory need to be predicted, the obstacle information, the road structure and initial information of the trajectory are initialized in advance. In the training process, the feature information is input into the decoder, and then gradually evolved into real obstacle information, road structure and trajectory.

At S203, parameters of the first model are iteratively trained based on the regulatory control sample set, and the trained first model is determined as a second model.

Optionally, the regulatory control sample set may include a plurality of driving-related samples and a trajectory corresponding to each driving-related sample at the next moment.

The iteratively training the parameters of the first model based on the regulatory control sample set, and determining the trained first model as the second model include:
inputting the driving-related samples in the regulatory control sample set into the first model to obtain a first predicted trajectory; and
training the parameters of the first model according to a difference between the first predicted trajectory and the trajectory at the next moment, and determining the trained first model as the second model.

It should be noted that, when the first model is trained, the first model is only trained based on the trajectory. A weight of a loss function corresponding to each of the obstacle information and the lane line information may be set to zero.

The initial trajectory generation model includes an initial backbone network, an initial encoder and an initial decoder. The driving-related samples include sensor samples and navigation planning samples. The sensor data samples include environment perception samples and state samples. The method of inputting the driving-related samples in the perception sample set into the initial trajectory generation model to obtain the first predicted trajectory may include: inputting the environment perception samples into the initial backbone network to obtain first fusion features; inputting the state samples and the navigation planning samples into the initial encoder to obtain first encoding features; and inputting the first encoding features and the first fusion features into the initialized initial decoder to obtain the first predicted trajectory.

The initial trajectory generation model includes an initial backbone network, an initial encoder and an initial decoder. The driving-related samples include sensor samples. The sensor data samples include environment perception samples and state samples. The method of inputting the driving-related samples in the perception sample set into the initial trajectory generation model to obtain the first predicted trajectory may include: inputting the environment perception samples into the initial backbone network to obtain first fusion features; inputting the state samples into the initial encoder to obtain first encoding features; and inputting the first encoding features and the first fusion features into the initialized initial decoder to obtain the first predicted trajectory.

The initial trajectory generation model includes an initial backbone network, an initial encoder, an initial decoder and a target memory module. The driving-related samples include sensor samples and navigation planning samples. The sensor data samples include environment perception samples and state samples. The method of inputting the driving-related samples in the perception sample set into the initial trajectory generation model to obtain the first predicted trajectory may include: inputting the environment perception samples into the initial backbone network to obtain first fusion features; determining a second fusion features according to the first fusion features and historical features output by the target memory module; inputting the state samples and the navigation planning samples into the initial encoder to obtain first encoding features; and inputting the first encoding features and the second fusion features into the initialized initial decoder to obtain the first predicted trajectory.

The initial trajectory generation model includes an initial backbone network, an initial encoder, an initial decoder and a target memory module. The driving-related samples include sensor samples. The sensor data samples include environment perception samples and state samples. The method of inputting the driving-related samples in the perception sample set into the initial trajectory generation model to obtain the first predicted trajectory may include: inputting the environment perception samples into the initial backbone network to obtain first fusion features; determining a second fusion features according to the first fusion features and historical features output by the target memory module; inputting the state samples into the initial encoder to obtain first encoding features; and inputting the first encoding features and the first fusion features into the initialized initial decoder to obtain the first predicted trajectory.

Specifically, the method of training the parameters of the first model according to the difference between the first predicted trajectory and the trajectory at the next moment may include: training the parameters of the first model based on a second loss function and the differences between the first predicted trajectory and the trajectory at the next moment. The second loss function may be a loss function in the prior art, which will not be limited in the embodiments of the present disclosure.

At S204, parameters of the second model are iteratively trained based on the perception sample set and the regulatory control sample set, and the trained second model is determined as the target trajectory generation model.

Specifically, the method of iteratively training the parameters of the second model based on the perception sample set and the regulatory control sample set and determining the trained second model as the target trajectory generation model may include: generating a fusion sample set based on the perception sample set and the regulatory control sample set; inputting the driving-related samples in the fusion sample set into the second model to obtain a second predicted obstacle, a second predicted road structure and a second predicted trajectory; and training the parameters of the second model according to a difference between the second predicted obstacle and the obstacle label, a difference between the second predicted road structure and the road structure label, and a difference between the second predicted trajectory and the trajectory at the next moment, and determining the trained second model as the target trajectory generation model.

Optionally, the iteratively training the parameters of the second model based on the perception sample set and the regulatory control sample set and determining the trained second model as the target trajectory generation model include:
generating a fusion sample set according to the perception sample set and the regulatory control sample set, wherein the fusion sample set includes a plurality of driving-related samples, and an obstacle label, a road structure label and a trajectory at the next moment corresponding to each driving-related sample;
inputting the driving-related samples in the fusion sample set into the second model to obtain a second predicted obstacle, a second predicted road structure and a second predicted trajectory; and
training the parameters of the second model according to a difference between the second predicted obstacle and the obstacle label, a difference between the second predicted road structure and the road structure label, and a difference between the second predicted trajectory and the trajectory at the next moment, and determining the trained second model as the target trajectory generation model.

Specifically, the method of generating the fusion sample set according to the perception sample seat and the regulatory control sample set may include: adding the obstacle labels and road structure labels corresponding to the driving-related samples in the perception sample set to the corresponding driving-related samples in the regulatory control sample set, and determining the regulatory control sample set that has been added with the obstacle labels and the road structure labels as a fusion sample set. The method of generating the fusion sample set according to the perception sample set and the regulatory control sample set may include: adding a trajectory corresponding to the driving-related samples in the perception sample set at the next moment to the corresponding driving-related samples in the perception sample set, and determining the perception sample set that has been added with the trajectory at the next moment as the fusion sample set.

The initial trajectory generation model includes an initial backbone network, an initial encoder and an initial decoder. The driving-related samples include sensor samples and navigation planning samples. The sensor data samples include environment perception samples and state samples. The method of inputting the driving-related samples in the perception sample set into the initial trajectory generation model to obtain the second predicted obstacle information, the second predicted road structure and the second predicted trajectory may include: inputting the environment perception samples into the initial backbone network to obtain first fusion features; inputting the state samples and the navigation planning samples into the initial encoder to obtain first encoding features; and inputting the first encoding features and the first fusion features into the initialized initial decoder to obtain the second predicted obstacle information, the second predicted road structure and the second predicted trajectory.

The initial trajectory generation model includes an initial backbone network, an initial encoder and an initial decoder. The driving-related samples include sensor samples. The sensor data samples include environment perception samples and state samples. The method of inputting the driving-related samples in the perception sample set into the initial trajectory generation model to obtain the second predicted obstacle information, the second predicted road structure and the second predicted trajectory may include: inputting the environment perception samples into the initial backbone network to obtain first fusion features; inputting the state samples into the initial encoder to obtain first encoding features; and inputting the first encoding features and the first fusion features into the initialized initial decoder to obtain the second predicted obstacle information, the second predicted road structure and the second predicted trajectory.

The initial trajectory generation model includes an initial backbone network, an initial encoder, an initial decoder and a target memory module. The driving-related samples include sensor samples and navigation planning samples. The sensor data samples include environment perception samples and state samples. The method of inputting the driving-related samples in the perception sample set into the initial trajectory generation model to obtain the second predicted obstacle information, the second predicted road structure and the second predicted trajectory may include: inputting the environment perception samples into the initial backbone network to obtain first fusion features; determining a second fusion features according to the first fusion features and historical features output by the target memory module; inputting the state samples and the navigation planning samples into the initial encoder to obtain first encoding features; and inputting the first encoding features and the second fusion features into the initialized initial decoder to obtain the second predicted obstacle information, the second predicted road structure and the second predicted trajectory.

The initial trajectory generation model includes an initial backbone network, an initial encoder, an initial decoder and a target memory module. The driving-related samples include sensor samples. The sensor data samples include environment perception samples and state samples. The method of inputting the driving-related samples in the perception sample set into the initial trajectory generation model to obtain the second predicted obstacle information, the second predicted road structure and the second predicted trajectory may include: inputting the environment perception samples into the initial backbone network to obtain first fusion features; determining a second fusion features according to the first fusion features and historical features output by the target memory module; inputting the state samples into the initial encoder to obtain first encoding features; and inputting the first encoding features and the second fusion features into the initialized initial decoder to obtain the second predicted obstacle information, the second predicted road structure and the second predicted trajectory.

Specifically, the method of training the parameters of the second model according to the difference between the second predicted obstacle and the obstacle label, the difference between the second predicted road structure and the road structure label, and the difference between the second predicted trajectory and the trajectory at the next moment may include: determining a third loss function based on the first loss function and the second loss function; and training the parameters of the second model based on the third loss function and the differences between the second predicted obstacle and the obstacle label, the difference between the second predicted road structure and the road structure label, and the difference between the second predicted trajectory and the trajectory at the next moment. The method of training the parameters of the second model according to the difference between the second predicted obstacle and the obstacle label, the difference between the second predicted road structure and the road structure label, and the difference between the second predicted trajectory and the trajectory at the next moment may include: training the parameters of the second model based on the third loss function and the differences between the second predicted obstacle and the obstacle label, the difference between the second predicted road structure and the road structure label, and the difference between the second predicted trajectory and the trajectory at the next moment. The third loss function may be a loss function in the prior art, which will not be limited in the embodiments of the present disclosure.

Optionally, the driving-related samples include sensor samples and navigation planning samples; the sensor data samples include environment perception samples and state samples; and the environment perception samples include frame samples and point cloud samples.

In a specific example, FIG. 3 is a flowchart of another method for generating a trajectory provided by an embodiment of the present disclosure. As shown in FIG. 3, the target trajectory generation model includes a target backbone network, a target encoder, a target decoder and a target memory module. Frame data collected by a camera and point cloud data collected by lidar are input into the target backbone network to obtain target fusion features, and the target fusion features are projected into the BEV space. The target BEV features are determined according to the target fusion features projected into the BEV space and the BEV features output by the target memory module, and the BEV features stored in the target memory module are updated according to the target BEV features. Position information of the current vehicle collected by GPS, attitude information of the current vehicle collected by a sensor, navigation planning information and driving rule information are input into the target encoder to obtain target encoding features. The target encoding features and the target BEV features are input into the target decoder to obtain the candidate driving trajectory, the first obstacle information, the second obstacle information and the road structure corresponding to the current vehicle. It should be noted that the target trajectory generation model is a pre-trained initial trajectory generation model (the initial trajectory generation model includes an initial backbone network, an initial encoder, an initial decoder and a target memory module). The method for training the initial trajectory generation model includes: a label-based supervised learning training method and a training method based on a label and a reward (that is, a first half uses a training method of supervised learning and a second half uses a training method of reinforced learning), wherein the reward is usually recorded as Rt, which represents a return reward value of a tth time step. For example, the training of the initial trajectory generation model may be divided into two stages. In the first stage, parameters of the initial trajectory generation model are trained by a label-based supervised learning training method. In the second stage, the model that has been trained in the first stage is trained based on supervised learning used in the first half and reinforced learning used in the second half. Specifically, the training process in the first stage includes: acquiring a perception sample set, wherein the perception sample set includes a plurality of driving-related samples, and a first-type obstacle label, a second-type obstacle label and a road structure label carried by each driving-related sample; the driving-related samples includes sensor samples and navigation planning samples; the sensor data samples include environment perception samples and state samples; the environment perception samples include frame samples and point cloud samples; and the state samples includes position samples and attitude samples. The initial decoder is initialized based on a preset instance. The frame samples and the point cloud samples are input into the initial backbone network to obtain the first fusion features, and the first fusion features are projected into the BEV space. First BEV features is determined according to the first fusion features projected into the BEV space and the BEV features output by the target memory module, and the BEV features stored in the target memory module are updated according to the first BEV features. The position samples, the attitude samples and the navigation planning samples are input into the initial encoder to obtain the first encoding features. The first encoding features and the first BEV features are input into the initialized initial decoder to obtain first predicted first-type obstacle information, first predicted second-type obstacle information and a first predicted road structure. The parameters of the initial trajectory generation model are trained according to a difference between the first predicted first-type obstacle information and the first-type obstacle label, a difference between the first predicted second-type obstacle information and the second-type obstacle label, and a difference between the first predicted road structure and the road structure label. The trained initial trajectory generation model is determined as the first model.

The regulatory control sample set is acquired. The regulatory control sample set includes samples with labels and samples without labels, and the labels of the samples are a trajectory of a next moment. The first model includes a first backbone network, a first encoder, a first decoder and a target memory module. In the front half of the training process in the second stage, the frame samples and the point cloud samples are input into the first backbone network to obtain the second fusion features, and the second fusion features are projected into the BEV space. Second BEV features are determined according to the second fusion features projected into the BEV space and the BEV features output by the target memory module, and the BEV features stored in the target memory module are updated according to the second BEV features. The position samples, the attitude samples and the navigation planning samples are input into the first encoder to obtain the second encoding features. The second encoding features and the second BEV features are input into the first decoder to obtain a first predicted trajectory. The parameters of the first model are trained according to a difference between the first predicted trajectory and the trajectory at the next moment to obtain a model trained in the front half.

The model trained in the first half includes a second backbone network, a second encoder, a second decoder and a target memory module.

In the second half of the training process in the second stage, the frame samples and the point cloud samples are input into the second backbone network to obtain third fusion features, and the third fusion features are projected into the BEV space. Third BEV features are determined according to the third fusion features projected into the BEV space and the BEV features output by the target memory module, and the BEV features stored in the target memory module are updated according to the third BEV features. The position samples, the attitude samples and the navigation planning samples are input into the second encoder to obtain third encoding features. The third encoding features and the third BEV features are input into the second decoder to obtain a first predicted trajectory. The model trained in the front half is trained according to the first predicted trajectory and the returned reward value; and after the second half of the training is completed, the target trajectory generation model is obtained.

In the technical solution of this embodiment, the training of the target trajectory generation model is divided into three stages. In the first stage, the parameters of the initial trajectory generation model are iteratively trained based on the perception sample set, and the trained initial trajectory generation model is determined as the first model. In the second stage, the parameters of the first model are iteratively trained based on the regulatory control sample set, and the trained first model is determined as the second model. In the third stage, the parameters of the second model are iteratively trained based on the perception sample set and the regulatory control sample set, and the trained second model is determined as the target trajectory generation model; and after the target trajectory generation model is obtained, the driving-related data of the current vehicle is input into the target trajectory generation model to obtain the candidate driving trajectory corresponding to the current vehicle. The information loss can be reduced, which in turn improves the accuracy of the predicted trajectory. Based on the candidate driving trajectory output by the target trajectory generation model, the vehicle can be controlled in parallel in transverse and longitudinal directions, instead of serial control. That is, the left and right control and the front and rear control are not separated, so that the vehicle can merge lanes or bypass obstacles in the driving process more smoothly.

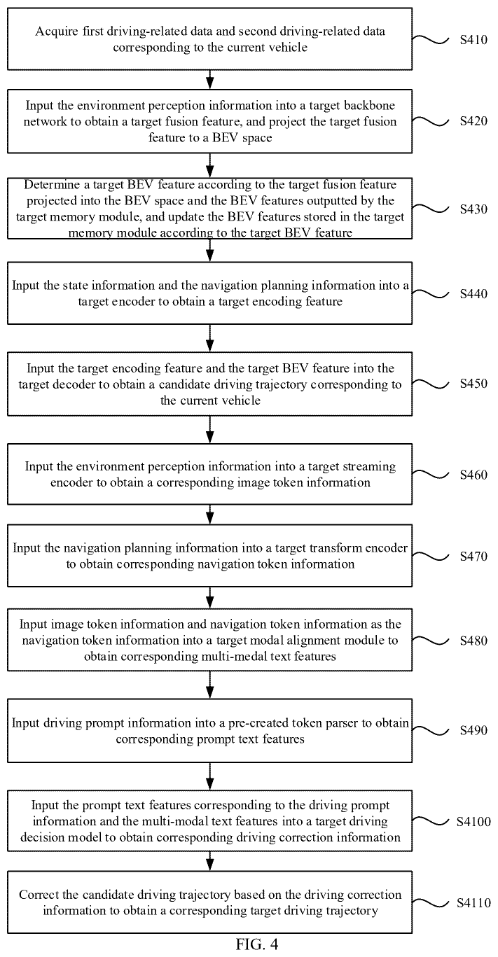

In one embodiment, FIG. 4 is a flowchart of another method for generating a trajectory provided by an embodiment of the present disclosure. The generation process of the target driving trajectory is further described in this embodiment on the basis of the above embodiments. In this embodiment, the target driving correction model includes a target streaming encoder, a target navigation encoder, a target modal alignment module and a target driving decision model. The target streaming encoder is configured to encode a video stream of the current vehicle. The target navigation encoder is configured to encode the navigation planning information of the current vehicle. The target modal alignment module is configured to perform feature space unification/alignment of multi-modal information (mapping to a text feature space). The target driving decision model is configured to output the corresponding driving correction information.

The first driving-related data includes sensor information and navigation planning information. The sensor information includes environment perception information and state information. The target trajectory generation model includes a target backbone network, a target encoder, a target decoder and a target memory module. The target memory module is configured to store BEV features in a time dimension and a spatial dimension.

The second driving-related data includes environment perception information, navigation planning information and driving prompt information.

As shown in FIG. 4, the method includes the following steps.

At S410, first driving-related data and second driving-related data corresponding to the current vehicle are acquired.

At S420, the environment perception information is input into the target backbone network to obtain a target fusion features, and the target fusion features is projected into a BEV space.

The environment perception information includes current frame data and current point cloud data. Specifically, the inputting the environment perception information into the target backbone network to obtain the target fusion features and projecting the target fusion features into the BEV space include: inputting the current frame data and the current point cloud data into the target backbone network to obtain the target fusion features, and projecting the target fusion features into the BEV space.

It should be noted that the projection of the target fusion features into the BEV space can be implemented by means of projection in the prior art.

Specifically, the method of determining the target BEV features according to the target fusion features projected into the BEV space and the BEV features output by the target memory module may include: superposing the target fusion features projected into the BEV space and the BEV features output by the target memory module, and determining the superimposed BEV features as the target BEV features. It should be noted that, when the target fusion features projected into the BEV space are superposed with the BEV features output by the target memory module, weights of the target fusion features projected into the BEV space and weights of the BEV features output by the target memory module can be preset. Then, according to the weights of the target fusion features projected into the BEV space and the weights of the BEV features output by the target memory module, the target fusion features projected into the BEV space and the BEV features output by the target memory module are weighted and summed.

At S430, target BEV features are determined according to the target fusion features projected into the BEV space and the BEV features output by the target memory module, and the BEV features stored in the target memory module are updated according to the target BEV features.

Specifically, the method of updating the BEV features stored in the target memory module according to the target BEV features may include: storing the target BEV features in the target memory module according to a storage rule corresponding to the target memory module, and deleting part/all of BEV features historically stored in the target memory module according to the storage rule. The method of updating the BEV features stored in the target memory module according to the target BEV features may also include: deleting all the historically stored BEV features in the target memory module, and storing part/all of the target BEV features in the target memory module according to the storage rule corresponding to the target memory module.

At S440, the state information and the navigation planning information are input into the target encoder to obtain target encoding features.

The state information may include position information of the current vehicle and attitude information of the current vehicle. Specifically, the inputting the state information and the navigation planning information into the target encoder to obtain the target encoding features includes: inputting the position information of the current vehicle, the attitude information of the current vehicle and the navigation planning information into the target encoder to obtain the target encoding features.

At S450, the target encoding features and the target fusion features are input into the target decoder to obtain the candidate driving trajectory corresponding to the current vehicle.

The target backbone network may be a convolutional neural network (CNN). The target encoder may be a Transformer model. The Transformer model is a deep learning model based on an attention mechanism.

It should be noted that the purpose of projecting the target fusion features into the BEV space is to project the features of the vehicle into the same dimension. Due to different heights of different vehicles, the position of the camera and the position of the lidar may also be different. By projecting the target fusion features into the BEV space, the features of the vehicle may all be projected into the same dimension, so there is no need to focus on the height of the vehicle, the position of the camera, and the position of the lidar. Therefore, the training speed of the model can be further promoted.

In order to improve a characterization ability of the model, the target trajectory generation model in this embodiment of the present disclosure includes a target memory module. The target memory module is configured to store the BEV features in the time dimension and the spatial dimension. For example, the target memory module may store BEV features up to 20 seconds ago, and BEV features in a distance of 200 meters. If only BEV features in one dimension are recorded, the information may be incomplete, which will affect the accuracy of the predicted trajectory. For example, if the vehicle is parked for a few minutes, the BEV features stored in the target memory model are all BEV features in a parked state, and the trajectory prediction based on the BEV features in the parked state will affect the accuracy of the predicted trajectory. In this embodiment of the present disclosure, the target memory module is configured to store the BEV features in the time dimension and the spatial dimension, which can ensure the integrity of the information, prevent the above situations and further improve the accuracy of the predicted trajectory.

In this embodiment of the present disclosure, the target trajectory generation model includes a target backbone network, a target encoder, a target decoder and a target memory module. Intermediate temporal features are memorized by the target memory module, including time dimension memory and spatial dimension memory, which can not only cope with special scenes, but also directly associate behaviors with input information to produce more refined and anthropomorphic behaviors and actions.

At S460, the environment perception information is input into the target streaming encoder to obtain corresponding image token information.

The target streaming encoder includes a target image feature extractor and a target temporal fusion module. Illustratively, the target streaming encoder may also be referred to as Streaming Video Encoder. The target image feature extractor may be ViT suitable for multi-resolution image processing, for example, may be a multi-resolution vision transformer (referred to as Multi-resolution ViT), i.e., a visual processing model based on a Transformer architecture, which can capture relationships and features among different parts in an image by using a multi-head attention mechanism and other operations. The target temporal fusion module may be a Temporal Encoder, which is configured to capture relationships among image information at different time points.

In one embodiment, S460 includes S4601-S4602.

At S4601, the environment perception information is input into the target image feature extractor to obtain corresponding environment perception encoding information.

The environment perception information may be presented in a form of a video stream or multiple frames of successive images. The environment perception encoding information refers to relevant information obtained by performing feature extraction and encoding on the environment perception information as an image or video stream. For example, the environment perception encoding information may include global features and image features in each frame of images. For example, the environment perception information is composed of N frames of images, and the N frames of images are input to the target image feature extractor, which may output N*H*W image features and N global features. The image features relatively focuses on the corresponding positions on the image, while the global features relatively focuses on key features on the image.

In this embodiment, in the case that the environment perception information is presented in the form of a video stream, the video stream needs to be divided into multiple frames of images which are then input to the target image feature extractor to obtain the corresponding environment perception encoding information. In the process of encoding the environment perception information, a class Token may be added at the same time to introduce global information, which can improve the performances of the model.

At S4602, the environment perception encoding information is input into the target temporal fusion module to obtain the corresponding image token information.

The image token information refers to a high-dimensional visual feature (which may be referred to as image Token) that represents local and global information obtained from the environment perception information by a feature extraction module. The target temporal fusion module is implemented based on a pooling layer and a temporal attention mechanism. That is, on the basis of Pooling, a SE structure is added, which can perform weighted fusion on multiple frames of temporal images and effectively reduce the number of tokens, thereby improving the training speed and inference speed. Meanwhile, the class Token may be added and global information may be introduced, thereby improving the performances of the model. In this embodiment, in the case that the environment perception information is N frames of images, image features of N*H*W and N global features may be used as input data of the target temporal fusion module to obtain the corresponding image token information, that is, H*W+N.

At S470, the navigation planning information is input into the target navigation encoder to obtain corresponding navigation token information.

The navigation planning information may be presented in the form of an image. The navigation token information refers to a high-dimensional visual feature (which may be referred to as navigation Token) that represent local and global information obtained from the navigation planning information by the feature extraction module. The target navigation encoder is configured to convert the input navigation planning information presented in the form of the image into a series of navigation token information. These pieces of navigation token information may capture feature information in the navigation planning information. Illustratively, the target navigation encoder may be a vision transformer encoder (ViT Encoder). Generally speaking, the VIT Encoder may process and understand image information better, which can improve the perception and decision-making abilities of an autonomous driving system under complex scenes. In addition, local features and global information in the image may be captured by the VIT Encoder, and more valuable image information may be provided for subsequent processing steps.

At S480, the image token information and the navigation token information are input into the target modal alignment module as driving token information to obtain mapped multi-modal features.

The target modal alignment module is configured to map the video features and navigation features to a text feature space, that is, to the same space as text features, so as to carry out unified processing and interaction. The mapped multi-modal features refer to multi-modal features mapped to the text feature space (aligned with the text features). That is, the image token information and the navigation token information are converted into features with similar forms and dimensions to a text of a LLM model. In this embodiment, the image token information and the navigation token information output by the target streaming encoder may be mapped to make it have similar forms and dimensions to the text representation in the LLM model, and thus may be fused, interacted and decoded with text features in subsequent processing.

At S490, the driving prompt information is input to the pre-created text feature extraction module to obtain the corresponding prompt text features.

The text feature extraction module includes a tokenizer and a word list. The driving prompt information may include a general prompt text and a scene-specific prompt text. In the case that the driving prompt information is text data, the prompt text features refer to a splitting of a text into smaller word units, that is, subwords, by the tokenizer, which are indexed to corresponding text features (word embedding) by the word list. In this embodiment, different types of driving prompt information may be uniformly converted into a Token sequence by the text feature extraction module, and may thus be input into a target driving decision model for processing and interaction, thereby implementing the planning of the vehicle's driving trajectory.

At S4100, prompt text features corresponding to the driving prompt information and the mapped multi-modal features are input into the target driving decision model to obtain corresponding driving correction information.

In this embodiment, the target driving decision model is configured to determine a specific scene where the current vehicle is driving based on the driving prompt information, and obtain recommended information for correcting the driving trajectory of the current vehicle according to the environment perception information and the navigation planning information. Illustratively, the target driving decision model may be a LLM model.

In one embodiment, S4100 includes S41001-S41002.

At S41001, environment perception encoding information and prompt text features of historical frames, and the driving correction information are stored in a memory storage space.

The memory storage space is a space that uses a memory mechanism to store scene information, and follows a queue mechanism, that is, first-in and first-out. In this embodiment, an available storage space of the memory storage space is limited. That is, the memory storage space is used to store image-related information of a fixed length, for example, store relevant information of N frames of images, that is, the environment perception encoding information, prompt text features and driving correction information corresponding to the N frames of images. In the actual storage process, before environment perception encoding information, prompt text features and driving correction information corresponding to an (N+1)th frame of image need to be stored in the memory storage space, environment perception encoding information, prompt text features and driving correction information corresponding to a first historical frame of image in the memory storage space need to be deleted from the memory storage space. Then, the environment perception encoding information, prompt text features and driving correction information corresponding to the (N+1)th frame of image are stored as the environment perception encoding information, prompt text features and driving correction information corresponding to the Nth frame of image in the memory storage space.

At S41002, the environment perception encoding information, prompt text features and driving correction information of the current frame are extracted from the memory storage space; the prompt text features of the current frame, the prompt text features of the historical frames and the driving correction information are fused; the environment perception encoding information of the current frame and the environment perception encoding information of the historical frames are fused; and the fused information is input into the target driving decision model to obtain the corresponding driving correction information.

In this embodiment, a cross-attention mechanism may be used to fuse the prompt text features of the current frame and the prompt text features of the historical frames respectively, the environment perception encoding information of the current frame and the environment perception encoding information of the historical frames are fused, and the driving correction information of the current frame and the driving correction information of the historical frames are fused. Specifically, the prompt text features of the current frame are composed into a sequence as query words (that is query), a sequence composed of the prompt text features of the historical frames, the driving correction information and the driving prompt information is used as a key and a value, and a relationship between the sequences is modeled and the effective information is aggregated by calculating the attention mechanism to obtain fused prompt text features. In one example, this is implemented on the basis of the pooling layer and the temporal attention mechanism. That is, an SE structure is added on the basis of Pooling, which can perform weighted fusion of the environment perception encoding information of the current frame and the environment perception encoding information of the historical frames.

At S4110, the candidate driving trajectory is corrected based on the driving correction information to obtain a corresponding target driving trajectory.

In the technical solution of this embodiment, based on the above embodiments, the target memory module for storing BEV features in the time dimension and spatial dimension is configured in the target trajectory generation model to ensure the integrity of the information, thereby improving the accuracy of the predicted trajectory. Meanwhile, the target driving correction model is obtained by continuously and iteratively training of a scene-specific prompt text sample, which can ensure that the target driving correction model can accurately give driving correction information for different complex driving scenes, thereby ensuring the driving safety of the vehicle.

In one embodiment, FIG. 5 is a flowchart of training of a target driving correction model provided by an embodiment of the present disclosure. This embodiment is a process of continuously and iteratively training the driving correction model used in the above information correction process. By continuously and iteratively training the pre-created initial driving correction model, the corresponding target driving correction model can be obtained.

As shown in FIG. 5, the process of training the target driving correction model includes the following steps.

At S510, a driving-related sample set is acquired.

The driving-related sample set is used to contain driving-related samples of a plurality of vehicles. Each driving-related sample refers to various information which are generated or collected by each vehicle in the driving process and can represent surrounding environment conditions of the vehicle, and the own state and driving operations of the vehicle. In this embodiment, driving-related samples corresponding to the plurality of vehicles may be acquired from a sample database to form the corresponding driving-related sample set. The driving-related sample set includes an environment perception sample set, a navigation planning sample set and a driving prompt sample set. The driving prompt sample set includes a general prompt text sample set and a scene-specific prompt text sample set. The environment perception sample set contains environment perception samples of the plurality of vehicles. A single environment perception sample refers to a single frame of information which is collected by a vehicle in the driving process and can represent surrounding environment conditions of the vehicle. The navigation planning sample set contains navigation planning samples of the plurality of vehicles, wherein each navigation planning sample refers to a real-time geographic position, map data and path planning information of a vehicle. The driving prompt sample set contains driving prompt samples of a plurality of vehicles. Each driving prompt sample refers to an instruction class text that defines and specifies an output by the model, which requires the model to describe a current driving environment of a vehicle and identify key objects and is a specific description or prompt that is used to guide the target driving correction model to think and inference.

At S520, the pre-constructed initial driving correction model is iteratively trained based on the drive-related sample set to obtain the corresponding target driving correction model.

The initial driving correction model refers to an untrained driving correction model. For example, the driving correction model is a VLM model, and the corresponding initial driving correction model is an initial VLM model. In one embodiment, the initial driving correction model includes an initial streaming encoder, an initial transform encoder, an initial modal alignment module and an initial driving decision model. The initial streaming encoder is an untrained streaming encoder. For example, if the streaming encoder is a Multi-resolution ViT, the corresponding initial streaming encoder is an initial multi-resolution ViT. The initial transform encoder refers to an untrained transform encoder. For example, the transform encoder is a ViT Encoder, and the corresponding initial transform encoder is an initial VIT Encoder. The initial modal alignment module refers to an untrained modal alignment module. For example, the modal alignment module is a Projection, and the corresponding initial modal alignment module is an initial Projection. The initial driving decision model refers to an untrained driving decision model. For example, the driving decision model is a LLM model, and the corresponding initial driving decision model is an initial LLM model.

The training process of the target driving correction model includes three stages. In the first stage, parameters of the initial modal alignment module are iteratively trained, parameters of the initial streaming encoder and the initial driving decision model remain unchanged, and the initial transform encoder is not provided. In the second stage, parameters of the initial streaming encoder, the initial driving decision model and the intermediate modal alignment module are iteratively trained, and the initial transform encoder is not provided. In the third stage, the initial transform encoder, the candidate streaming encoder, the candidate driving decision model and the candidate modal alignment module are iteratively trained to obtain a corresponding target navigation encoder, target streaming encoder, target driving decision model and target modal alignment module, which constitute the corresponding target driving correction model.

In one embodiment, S520 includes S5201-S5203.

At S5201, the initial modal alignment module in the initial driving correction model is iteratively trained based on the environment perception sample set and the prompt text sample set to obtain the corresponding intermediate modal alignment module.

The environment perception sample set and the prompt text sample set are derived from a video/image-text pair constructed from public datasets. In the first stage of the training process, the environment perception sample set and the prompt text sample set are both general knowledge data. In the first stage of the training process, the environment perception sample set is input into the initial streaming encoder, text features corresponding to the prompt text information are input to the initial driving decision model, and the parameters of the initial modal alignment module are continuously and iteratively trained to obtain the corresponding intermediate modal alignment module. In the training process, the parameters of the initial modal alignment module need to be adjusted, such that the image features can be aligned with a word embedding space of the pre-trained driving decision model, so as to realize the effective fusion and interaction of image and text features, which can help the driving decision model better understand and process multi-modal information, and then achieve an effect of multi-modal feature alignment.

At S5202, the initial streaming encoder and the initial driving decision model in the initial driving correction model and the intermediate modal alignment module are iteratively trained based on the environment perception sample set and the prompt text sample set to obtain a corresponding candidate streaming encoder, candidate driving decision model and candidate modal alignment module.

The environment perception sample set and the prompt text sample set are derived from a video/image-text pair constructed from public datasets. In the second stage of the training process, the environment perception sample set and the prompt text sample set include general knowledge data and driving-related data, respectively. In the second stage of the training process, the environment perception sample set is input into the initial streaming encoder, and the general prompt text features corresponding to the general prompt text information in the general prompt text sample set are input into the initial driving decision model; and the parameters of the initial streaming encoder, the initial driving decision model and the intermediate modal alignment module are continuously and iteratively trained to obtain the corresponding candidate streaming encoder, candidate driving decision model and candidate modal alignment module.

At S5203, the initial transform encoder in the initial driving correction model, the candidate streaming encoder, the candidate driving decision model and the candidate mode alignment module are iteratively trained based on the environment perception sample set, the navigation planning sample set and the scene-specific prompt text sample set to obtain the corresponding target driving correction model.

The environment perception sample set and the prompt text sample set are derived from a video/image-text pair constructed from public datasets. In the third stage of the training process, the environment perception sample set and the prompt text sample set include driving data related to downstream business. In the third stage of the training process, the environment perception sample set is input into the candidate streaming encoder, the navigation planning sample set is input into the initial transform encoder, and the scene-specific prompt text features corresponding to the scene-specific prompt text information in the scene-specific prompt text sample set are input into the candidate driving decision model; and the initial transform encoder, the candidate streaming encoder, the candidate driving decision model and the candidate modal alignment module are iteratively trained to obtain the corresponding target navigation encoder, target streaming encoder, target driving decision model and target modal alignment module, which constitute the corresponding target driving correction model.

In the training process, the driving correction model can be iteratively trained by using multiple rounds of prompt text sample sets. Specifically, in the third stage of the training process, the driving correction model may output a text in a fixed format, including, for example, a driving scene, driving operation correction information and a driving reference position. In the third stage of the training process, by a multi-round dialogue form of CoT, the model may be guided to pay attention to more relevant elements according to a result of single-round output, and the content of the single-round dialogue output may be corrected and supplemented. For example, the corresponding output may be carried out with the change of the scene to correct the output of the previous round and further supplement the information. Illustratively, additional questions may be asked for individual scenes, for example, for a T-junction, whether there is a supplement to additional scene information such as a stop sign, so as to correct the driving correction information output by the driving correction model.

It should be noted that in the training process of the target driving correction model, the navigation planning information may not be configured. Certainly, the accuracy of the driving correction information output by the corresponding target driving correction model will be reduced accordingly.

In the technical solution of this embodiment, the driving information of end-to-end output is corrected by continuously and iteratively training the driving decision model using general knowledge data and intelligent driving-related data in the first stage and the second stage, and then continuously and iteratively training the driving decision model in a specific scene by using driving data closely related to downstream tasks in the third stage, thereby ensuring that the driving decision model can also give more accurate driving correction information for different complex driving scenes, and also ensuring the safety of automatic driving.

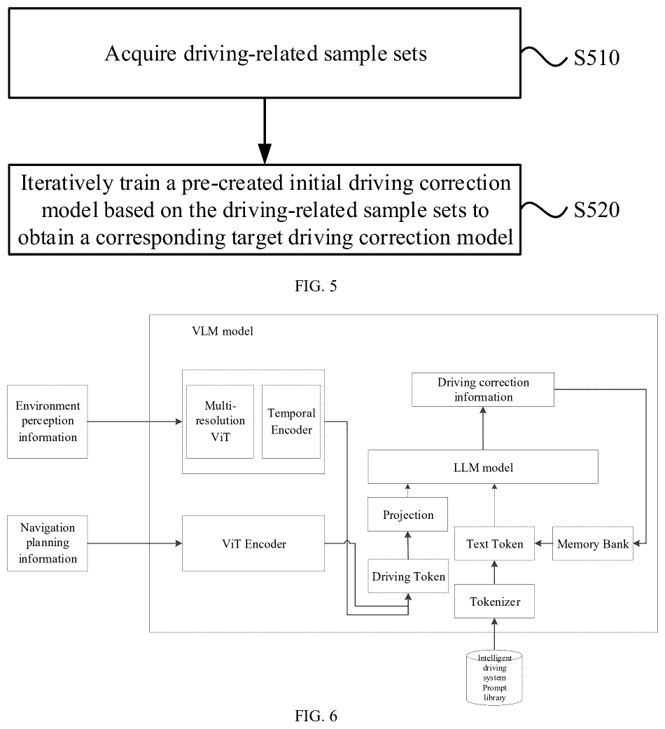

In one embodiment, FIG. 6 is a schematic diagram of implementation of information correction provided by an embodiment of the present disclosure. In this embodiment, the implementation process of information correction is described by taking the target driving correction model being the VLM model, the target streaming encoder being a Streaming Video Encoder, the target image feature extractor being a Multi-resolution ViT, the target temporal fusion module being a Temporal Encoder, the target navigation encoder being a VIT Encoder, the text feature extraction module being a Tokenizer and a word list, the target modal alignment module being a Projection, a prompt text library of intelligent driving being a Prompt library of an intelligent driving system and the memory storage space being a Memory Bank as examples. As shown in FIG. 6, the relationships among various modules included in the VLM model are as follows.

Firstly, the environment perception information corresponding to the current vehicle is input into the Streaming Video Encoder in the form of a video stream, and the image features are extracted by the Multi-resolution ViT in the Streaming Video Encoder to obtain corresponding image features and global features; and then, the image features and global features are input to the Temporal Encoder for temporal encoding to obtain the corresponding image token information.

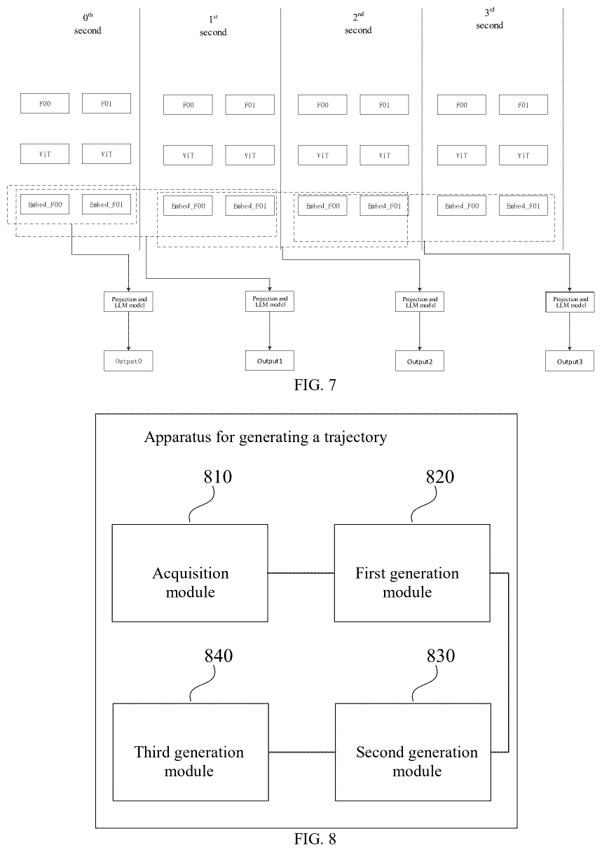

FIG. 7 is a flowchart of implementation of temporal fusion provided by an embodiment of the present disclosure. In this embodiment, the temporal fusion process is described by taking the driving-related data of each second as driving-related data corresponding to two frames as an example. As shown in FIG. 7, driving-related data within 4 seconds (that is, 0th second, 1st second, 2nd second, and 3rd second) is taken as driving-related data in the corresponding 4 frames. F00 represents the environment perception information presented in the form of a video stream at the 0th second; F01 represents the navigation planning information at the 0th second; F10 represents the environment perception information presented in the form of a video stream at the 1st second; F11 represents the navigation planning information at the 1st second; F20 represents the environment perception information presented in the form of a video stream at the 2nd second; F21 represents the navigation planning information at the 2nd second; F30 represents the environment perception information presented in the form of a video stream in the 3rd second; F31 represents the navigation planning information at the 3rd second. ViT includes a Multi-resolution ViT and a Temporal Encoder, and a ViT Encoder. The environment perception information presented in the form of a video stream per second is input to the Multi-resolution ViT and the Temporal Encoder, and the navigation planning information per second is input to the VIT Encoder, respectively, to obtain the corresponding image token information and navigation token information, that is, Embed_F00, Embed_F01, Embed_F10, Embed_F11, Embed_F20, Embed_F21, Embed_F30 and Embed_F31, wherein Embed_F00 represents the image token information at the 0th second; Embed_F01 represents the navigation token information at the 0th second; Embed_F10 represents the image token information at the 1st second; Embed_F11 represents the navigation token information at the 1st second; Embed_F20 represents the image token information at the 2nd second; Embed_F21 represents the navigation token information at the 2nd second; Embed_F30 represents the image token information at the 3rd second; and Embed_F31 represents the navigation token information at the 3rd second. Then, the image token information and the navigation token information per second are input to the Projection and the LLM model to obtain the corresponding driving correction information as the corresponding output information (that is, Output0, Output1, Output2, and Output3).

Then, the navigation planning information corresponding to the current vehicle is input into the VIT Encoder in the form of an image to obtain the corresponding navigation token information.

Then, the image token information and the navigation token information are input into the Projection as driving token information (referred to as driving Token), and the image token information and the navigation token information are mapped to the same space as the text features to obtain corresponding multi-modal features (mapped multi-modal features for short) mapped to the text feature space (aligned with the text features).

Then, the scene-specific prompt text information that matches the driving scene of the current vehicle is searched from the Prompt library of the intelligent driving system, the scene-specific prompt text information is input into the Tokenizer, and a plurality of pieces of text label information are looked up in the word list to form the corresponding prompt text features.

Then, the environment perception encoding information, prompt text features and driving correction information of the current frame are extracted from a pre-constructed Memory Bank; the prompt text features of the current frame, the prompt text features of the historical frames and the driving correction information are fused; and the environment perception encoding information of the current frame and the environment perception encoding information of the historical frames are fused.

Finally, the fused mapped multi-modal features and prompt text features are input into the LLM model, and the corresponding driving correction information is output.

It should be noted that the driving rule information in the present disclosure is part of the information in the driving correction information, that is, similar to the driving operation correction information.

FIG. 8 is a schematic structural diagram of an apparatus for generating a trajectory provided by an embodiment of the present disclosure. The apparatus for generating the trajectory in this embodiment is integrated in a vehicle end of the current vehicle. As shown in FIG. 8, the apparatus includes an acquisition module 810, a first generation module 820, a second generation module 830 and a third generation module 840.

The acquisition module 810 is configured to acquire driving-related data corresponding to the current vehicle.

The first generation module 820 is configured to input first driving-related data in the driving-related data to a pre-created target trajectory generation model to obtain a candidate driving trajectory corresponding to the current vehicle.

The second generation module 830 is configured to input second driving-related data in the driving-related data into a pre-created target driving correction model to obtain corresponding driving correction information.

The third generation module 840 is configured to correct the candidate driving trajectory based on the driving correction information to obtain a corresponding target driving trajectory.

In one embodiment, the second driving-related data includes sensor information and navigation planning information. The sensor information includes environment perception information and state information. The target trajectory generation model includes a target backbone network, a target encoder, a target decoder and a target memory module. The target memory module is configured to store BEV features in a time dimension and a spatial dimension.

The first generation module 820 is specifically configured to:
input the environment perception information into the target backbone network to obtain target fusion features, and project the target fusion features into a BEV space;
determine target BEV features according to the target fusion features projected into the BEV space and the BEV features output by the target memory module, and update the BEV features stored in the target memory module according to the target BEV features;
input the state information and the navigation planning information into the target encoder of the second chip to obtain target encoding features; and
input the target encoding features and the target fusion features into the target decoder to obtain the candidate driving trajectory corresponding to the current vehicle.

In one embodiment, the process of training the target trajectory generation model includes:
acquiring a perception sample set, a regulatory control sample set and an initial trajectory generation model;
iteratively training parameters of the initial trajectory generation model based on the perception sample set, and determining the trained initial trajectory generation model as a first model;
iteratively training parameters of the first model based on the regulatory control sample set, and determining the trained first model as a second model; and
iteratively training parameters of the second model based on the perception sample set and the regulatory control sample set, and determining the trained second model as the target trajectory generation model.

In one embodiment, the perception sample set includes a plurality of driving-related samples, and an obstacle label and a road structure label carried by each driving-related sample.

The iteratively training parameters of the initial trajectory generation model based on the perception sample set, and determining the trained initial trajectory generation model as the first model are specifically configured to:
input the driving-related samples in the perception sample set into the initial trajectory generation model to obtain first predicted obstacle information and a first predicted road structure; and
train parameters of the initial trajectory generation model according to a difference between the first predicted obstacle information and the obstacle label, and a difference between the first predicted road structure and the road structure label, and determine the trained initial trajectory generation model as the first model.

In one embodiment, the regulatory control sample set may include a plurality of driving-related samples and a trajectory corresponding to each driving-related sample at a next moment.

The iteratively training the parameters of the first model based on the regulatory control sample set, and determining the trained first model as the second model are specifically configured to:
input the driving-related samples in the regulatory control sample set into the first model to obtain a first predicted trajectory; and
train the parameters of the first model according to a difference between the first predicted trajectory and the trajectory at the next moment, and determine the trained first model as the second model.

In one embodiment, the iteratively training the parameters of the second model based on the perception sample set and the regulatory control sample set, and determining the trained second model as the target trajectory generation model are specifically configured to:
generate a fusion sample set according to the perception sample set and the regulatory control sample set, wherein the fusion sample set includes a plurality of driving-related samples, and an obstacle label, a road structure label and a trajectory at the next moment corresponding to each driving-related sample;
input the driving-related samples in the fusion sample set into the second model to obtain a second predicted obstacle, a second predicted road structure and a second predicted trajectory; and
train the parameters of the second model according to a difference between the second predicted obstacle and the obstacle label, a difference between the second predicted road structure and the road structure label, and a difference between the second predicted trajectory and the trajectory at the next moment, and determine the trained second model as the target trajectory generation model.

In one embodiment, the driving-related samples include sensor samples and navigation planning samples; the sensor data samples include environment perception samples and state samples; and the environment perception samples include frame samples and point cloud samples.

In one embodiment, the initial trajectory generation model includes an initial backbone network, an initial encoder, an initial decoder and a target memory module.

The inputting the driving-related samples in the perception sample set into the initial trajectory generation model to obtain the first predicted obstacle information and the first predicted road structure is specifically configured to:
initialize the initial decoder based on a preset instance;
input the environment perception samples into the initial backbone network to obtain first fusion features, and project the first fusion features into the BEV space;
determine first BEV features according to the first fusion features projected into the BEV space and BEV features output by the target memory module, and update the BEV features stored in the target memory module according to the first BEV features;
input the state samples and the navigation planning samples into the initial encoder to obtain the first encoding features; and
input the first encoding features and the first BEV features into the initialized initial decoder to obtain the first predicted obstacle information and the first predicted road structure.

In one embodiment, the inputting the first driving-related data in the driving-related data to the pre-created target trajectory generation model to obtain the candidate driving trajectory corresponding to the current vehicle is specifically configured to:
input the driving-related data into the target trajectory generation model to obtain the candidate driving trajectory, obstacle information and a road structure corresponding to the current vehicle.

In one embodiment, the obstacle information includes first-type obstacle information and second-type obstacle information.

In one embodiment, the target driving correction model includes a target streaming encoder, a target navigation encoder, a target modal alignment module and a target driving decision model; the driving-related data includes environment perception information, navigation planning information and driving prompt information; and the second generation module 830 includes:
a first generation unit, configured to input the environment perception information into the target streaming encoder to obtain corresponding image token information;
a second generation unit, configured to input the navigation planning information into the target navigation encoder to obtain corresponding navigation token information;
a third generation unit, configured to input the image token information and the navigation token information into the target modal alignment module as driving token information to obtain mapped multi-modal features; and
a fourth generation unit, configured to input prompt text features corresponding to the driving prompt information and the mapped multi-modal features into the target driving decision model to obtain corresponding driving correction information.

In one embodiment, the target streaming encoder includes a target image feature extractor and a target temporal fusion module. The first generation unit includes:
a first generation subunit, configured to input the environment perception information into the target image feature extractor to obtain corresponding environment perception encoding information; and
a second generation subunit, configured to input the environment perception encoding information into the target temporal fusion module to obtain the corresponding image token information.

In one embodiment, the driving correction information includes at least one of the followings: a driving reference position, a driving scene, and driving operation correction information.

In one embodiment, the second generation module 830 further includes:
a conversion unit, configured to input prompt text features corresponding to the driving prompt information and the mapped multi-modal features into the target driving decision model to obtain corresponding driving correction information, and input the driving prompt information into the pre-created text feature extraction module to obtain corresponding prompt text features.

In one embodiment, the fourth generation unit includes:
a storage subunit, configured to store environment perception encoding information and prompt text features of historical frames, and the driving correction information in a memory storage space; and
a third generation subunit, configured to extract the environment perception encoding information, prompt text features and driving correction information of the current frame from the memory storage space; fuse the prompt text features of the current frame, the prompt text features of the historical frames and the driving correction information; fuse the environment perception encoding information of the current frame and the environment perception encoding information of the historical frames; and input the fused information into the target driving decision model to obtain the corresponding driving correction information.

In one embodiment, the process of training the target driving correction model includes:
acquiring a driving-related sample set; and
iteratively training the pre-constructed initial driving correction model based on the driving-related sample set to obtain the corresponding target driving correction model.

In one embodiment, the initial driving correction model includes an initial streaming encoder, an initial transform encoder, an initial modal alignment module and an initial driving decision model. The driving-related sample set includes an environment perception sample set, a navigation planning sample set and a driving prompt sample set. The driving prompt sample set includes a prompt text sample set and a scene-specific prompt text sample set.

The iteratively training the pre-constructed initial driving correction model based on the driving-related sample set to obtain the corresponding target driving correction model is specifically configured to:
iteratively train the initial modal alignment module in the initial driving correction model based on the environment perception sample set and the prompt text sample set to obtain the corresponding intermediate modal alignment module;
iteratively train the initial streaming encoder and the initial driving decision model in the initial driving correction model and the intermediate modal alignment module based on the environment perception sample set and the prompt text sample set to obtain a corresponding candidate streaming encoder, candidate driving decision model and candidate modal alignment module; and
iteratively train the initial transform encoder in the initial driving correction model, the candidate streaming encoder, the candidate driving decision model and the candidate mode alignment module based on the environment perception sample set, the navigation planning sample set and the scene-specific prompt text sample set to obtain the corresponding target driving correction model.

The apparatus for generating the trajectory provided by the embodiment of the present disclosure may execute the method for generating the trajectory provided by any embodiment of the present disclosure, and has corresponding functional modules and beneficial effects of an execution method.

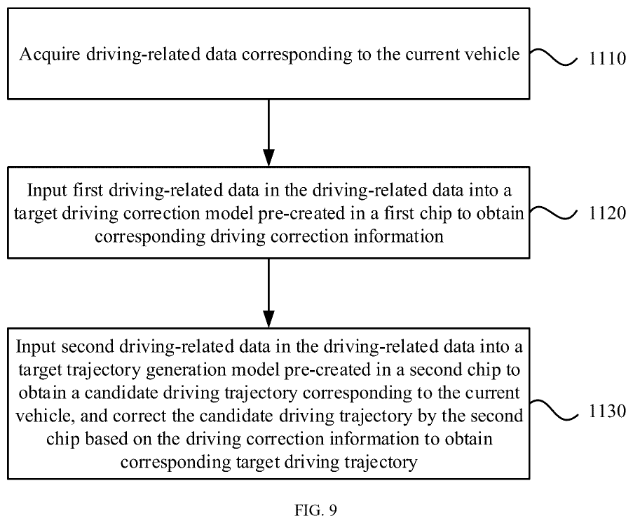

FIG. 9 is a flowchart of a method for generating a trajectory provided by an embodiment of the present disclosure. This embodiment may be applicable to a situation where a trajectory is generated in a chip set. This method may be executed by an apparatus for generating a trajectory. This apparatus may be implemented in the form of hardware and/or software. This apparatus may be configured in a chip set including a first chip and a second chip. As shown in FIG. 9, the method includes the following steps.

At step 1110, driving-related data corresponding to a current vehicle is acquired.

For details about the specific embodiment of this step, see the specific description of step 110 as described above.

At step 1120, second driving-related data in the driving-related data is input into a target driving correction model pre-created by the first chip to obtain corresponding driving correction information.

Specifically, the first chip is deployed with the target driving correction model. The target driving correction model includes a target streaming encoder, a target navigation encoder, a target modal alignment module and a target driving decision model. The target streaming encoder is configured to encode a video stream of the current vehicle. The target navigation encoder is configured to encode the navigation planning information of the current vehicle. The target modal alignment module is used to perform feature space unification/alignment of multi-modal information (mapping to a text feature space). The target driving decision model is configured to output the corresponding driving correction information.

In this embodiment, the driving-related data of the current vehicle is input into the target driving correction model to obtain recommended information on whether acceleration, deceleration, and steering operations are required, and the recommended information is input into the pre-created target trajectory generation model as the driving correction information, such that the target trajectory generation model corrects the trajectory based on the driving correction information to obtain the corresponding target driving trajectory, and then the current vehicle automatically drives according to the target driving trajectory.

In the technical solution of this embodiment, the corresponding driving correction information is obtained by acquiring the driving-related data of the current vehicle in the driving process, and inputting the driving-related data into the pre-created target driving correction model. The pre-generated driving trajectory is automatically corrected by the driving correction information. Therefore, the problem of poor correction effect caused by the use of manual correction for the driving trajectory in the prior art is effectively avoided, and the accuracy and effectiveness of driving trajectory correction are improved.

At step 1130, first driving-related data in the driving-related data is input into a target trajectory generation model pre-created by the second chip to obtain a candidate driving trajectory corresponding to the current vehicle; and the candidate driving trajectory is corrected by the second chip based on the driving correction information to obtain a corresponding target driving trajectory.

The candidate driving trajectory may be information used to determine the target trajectory. The candidate driving trajectory is a predicted trajectory within a period of time in the future. For example, the candidate driving trajectory may be a predicted trajectory within the next 8 seconds.

In this embodiment, the driving correction information generated by the first chip is input into the target trajectory generation model pre-created by the second chip, such that the target trajectory generation model corrects the candidate driving trajectory based on the driving correction information to obtain the corresponding target driving trajectory, and then the current vehicle automatically drives according to the target driving trajectory.

In this embodiment of the present disclosure, the corresponding driving correction information is obtained by acquiring the second driving-related data and the first driving-related data of the current vehicle in the driving process, and inputting the second driving-related data into the target driving correction model pre-created by the first chip; the corresponding candidate driving trajectory is obtained by inputting the first driving-related data into the target trajectory generation model of the second chip; and the pre-generated candidate driving trajectory is automatically corrected by the second chip by the driving correction information to obtain the corresponding target driving trajectory. Therefore, the problem of poor correction effect caused by the use of manual correction for the driving trajectory in the prior art is effectively avoided, and the accuracy and effectiveness of driving trajectory correction are improved.

In one example, the correction process includes three implementations. In addition, these three implementations are becoming more and more deeply combined. In the first implementation, the target driving correction model outputs some macroscopic and long-term driving decision suggestions (e.g., transverse and longitudinal), and directly takes the driving decision suggestions as input data and inputs them to the target trajectory generation model, so as to ensure that the driving trajectory output by the target trajectory generation model is more in line with more macro suggestions, thereby generating a target driving trajectory that conforms to the macro driving decision. In the second implementation, the target driving correction model outputs some macroscopic and long-term driving decision suggestions (e.g., transverse and longitudinal), and presents the driving decision suggestions in the form of feature vectors (i.e., encoding of the feature vectors for the driving decision suggestions), and input the encoded feature vectors into the target trajectory generation model as input data to ensure that the target trajectory generation model outputs more correct driving decisions and driving trajectories. In the third implementation, by selecting, through a learned model router, whether the corresponding target driving trajectory is output by the target trajectory generation model or the target driving correction model, the target trajectory generation model can be directly used under complex scenes to output more accurate driving decisions and driving trajectories, thereby avoiding the deviations of the driving decision and driving trajectory output by the target driving correction model.

In one example, the target trajectory generation model is a high-frequency system (e.g., runs at a frequency between 30 Hz and 100 Hz) and continuously outputs candidate driving trajectories. The target driving correction model is a low-frequency system (i.e., two inferences per one or two seconds).

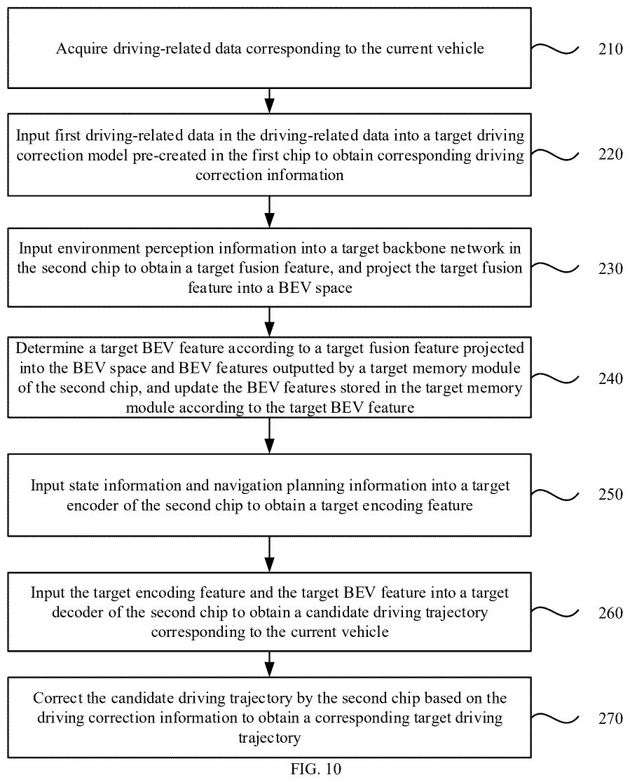

FIG. 10 is a flowchart of another method for generating a trajectory provided by an embodiment of the present disclosure. The generation process of the candidate driving trajectory is further described in this embodiment. Referring to FIG. 10, the method provided by this embodiment of the present disclosure includes the following steps.

At step 210, driving-related data corresponding to a current vehicle is acquired, wherein the first driving-related data in the driving-related data includes sensor information and navigation planning information. The sensor information includes environment perception information and state information. The target trajectory generation model includes a target backbone network, a target encoder, a target decoder and a target memory module. The target memory module is configured to store BEV features in a time dimension and a spatial dimension.

At step 220, second driving-related data in the driving-related data is input into a target driving correction model pre-created by the first chip to obtain corresponding driving correction information.

At step 230, the environment perception information is input into the target backbone network of the second chip to obtain target fusion features, and the target fusion features is projected into a BEV space.

At step 240, target BEV features is determined according to the target fusion features projected into the BEV space and the BEV features output by the target memory module of the second chip, and the BEV features stored in the target memory module are updated according to the target BEV features.

At step 250, the state information and the navigation planning information are input into the target encoder of the second chip to obtain target encoding features.

At step 260, the target encoding features and the target BEV features are input into the target decoder of the second chip to obtain the candidate driving trajectory corresponding to the current vehicle.

In this embodiment of the present disclosure, the target decoder may be configured in the second chip. The target encoding features and the target BEV features may be decoded in the target decoder of the second chip, so as to generate the candidate driving trajectory of the current vehicle. The candidate driving trajectory is a predicted trajectory within a period of time in the future. For example, the candidate driving trajectory may be a predicted trajectory within the next 8 seconds.

At step 270, the candidate driving trajectory is corrected by the second chip based on the driving correction information to obtain the corresponding target driving trajectory.

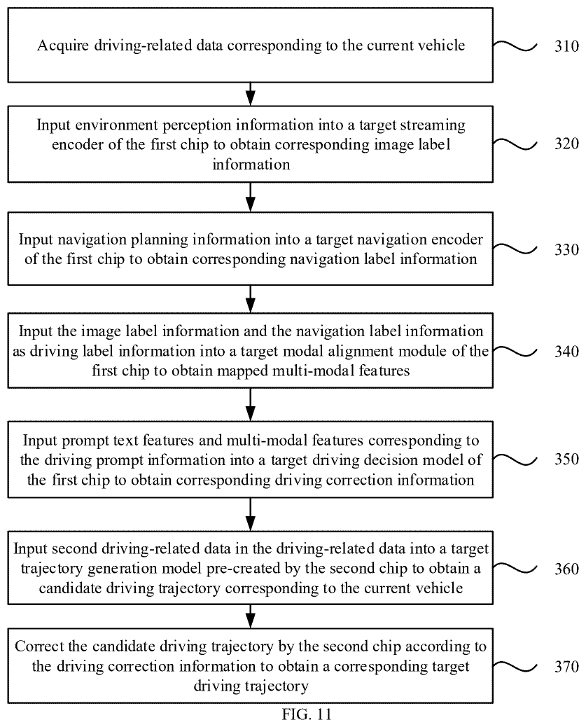

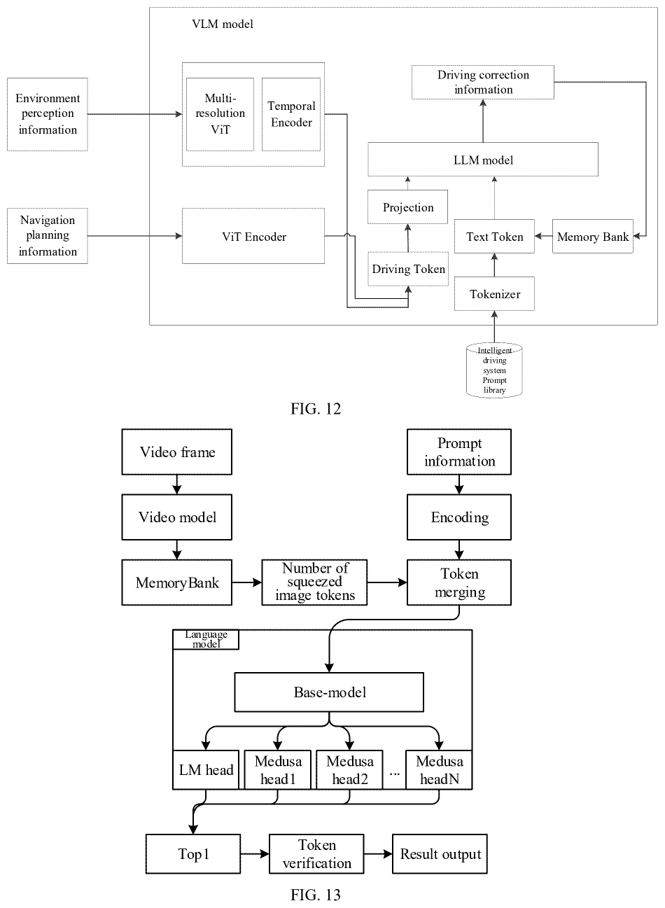

FIG. 11 is a flowchart of another method for generating a trajectory provided by an embodiment of the present disclosure. The generation process of the candidate driving trajectory in the above embodiment is described in this embodiment, Referring to FIG. 11, the method provided by the embodiment of the present disclosure includes the following steps.

At step 310, the driving-related data corresponding to the current vehicle is acquired, wherein the driving-related data includes at least second driving-related data; the target driving correction model includes at least a multi-modal model; the target driving correction model includes a target streaming encoder, a target navigation encoder, a target modal alignment module and a target driving decision model; and the second driving-related data includes environment perception information, navigation planning information and driving prompt information.

At step 320, the environment perception information is input into the target streaming encoder of the first chip to obtain corresponding image token information.

In this embodiment of the present disclosure, the inputting the environment perception information into the target streaming encoder of the first chip to obtain the corresponding image token information includes S3201-S3202.

At S3201, the environment perception information is input into the target image feature extractor to obtain corresponding environment perception encoding information.

At S3202, the environment perception encoding information is input into the target temporal fusion module to obtain the corresponding image token information.

At step 330, the navigation planning information is input into the target navigation encoder of the first chip to obtain the corresponding navigation token information.

At step 340, the image token information and the navigation token information are input into the target modal alignment module of the first chip as driving token information to obtain mapped multi-modal features.

At step 350, prompt text features corresponding to the driving prompt information and the multi-modal features are input into the target driving decision model of the first chip to obtain the corresponding driving correction information.

In one embodiment, S350 includes S3501-S3502.

At S3501, environment perception encoding information and prompt text features of historical frames, and the driving correction information are stored in a memory storage space.

At S3502, the environment perception encoding information, prompt text features and driving correction information of the current frame are extracted from the memory storage space; the prompt text features of the current frame, the prompt text features of the historical frames and the driving correction information are fused; the environment perception encoding information of the current frame and the environment perception encoding information of the historical frames are fused; and the fused information is input into the target driving decision model to obtain the corresponding driving correction information.

At step 360, the first driving-related data in the driving-related data is input to a target trajectory generation model pre-created by the second chip to obtain the candidate driving trajectory corresponding to the current vehicle.

At step 370, the candidate driving trajectory is corrected by the second chip based on the driving correction information to obtain the corresponding target driving trajectory.

In some embodiments of the present disclosure, the method further includes: performing squeeze processing on token information of the first driving-related data on the first chip to reduce a data amount of the token information.

The data amount of data may be a scale of the token information. The data amount may include token data, the amount of data carried by each token and other information. The data amount may directly affect the processing efficiency of the token information in a preset multi-modal model.

Specifically, in order to ensure the processing efficiency of the preset multi-modal model, especially in an in-vehicle chip of an intelligent vehicle, the number of token information may be subjected to squeeze processing. On the premise of ensuring the integrity of features of the token information, the number of the token information is reduced. For example, the token information includes A, B, and C, wherein the token information may be subjected to squeeze processing into A and B, and the squeeze processing may include C with less feature content of the token information. Alternatively, the token information includes A, B and C, and the token information may be squeezed into D and E, wherein the dimensions of D and E may be the same as those of A, B and C, and the squeeze processing can reduce the number of tokens in the token information. Alternatively, the token information includes A, B, and C, and the token information may be squeezed into a, b, and c, wherein the dimensions of a, b, and c may be smaller than that of the corresponding A, B, and C respectively, and the squeeze processing may include reducing the dimensions of tokens in the token information. In this embodiment of the present disclosure, the data amount in the token information is squeezed by one or more specific embodiments of squeeze processing. The squeeze processing for the token information may be achieved in specific ways, such as downsampling of the token information, pooling of the token information, and attention fusion of the token information.

Based on the embodiment of the present disclosure, the performing squeeze processing on the token information in the second driving-related data on the first chip includes: calling the first chip to perform attention pooling processing and squeeze and excitation processing on the token information in sequence; and calling the first chip to perform convolutional pooling processing on the processed token information, and taking the processed token information as new token information.

The attention pooling processing can extract and summarize key information in a sequence composed of the token information, the weight of each token information in the sequence can be calculated to determine its contribution to a summary result, and the attention pooling processing of the token information can be used to improve spatial feature extraction of the information. However, the squeeze and excitation processing may be token information processing that is implemented by a squeeze and excitation network (SENet). The SENet network may include a squeeze part and an excitation part. The squeeze part may be used to squeeze the dimension of the input token information. The squeeze process can be achieved by averaged pooling, while the excitation part may be added with a fully-connected layer for the token information of the obtained squeeze dimension. The importance of each channel in the token information is predicted, and then excited to a channel corresponding to the original token information, thereby achieving the extraction of time-domain related features of the token information.

In this embodiment of the present disclosure, after the token information is acquired, the token information may be subjected to attention pooling processing to generate a query vector, a key vector and a value vector respectively corresponding to the token information. An attention weight parameter of each channel may be determined by processing normalized parameters among the query vector, the key vector and the value vector. The attention weight parameter is injected into each channel in the token information, and each channel is processed by averaged pooling or maximum pooling according to the attention weight parameter, thereby realizing the attention pooling processing of the token information. Then, the squeeze and excitation network may be used to process the token information processed by attention pooling, and the dimension of the token information is squeezed by the squeeze part. The importance of the squeezed token information is predicted and then applied to the channel corresponding to the original token information by the fully-connected layer, thereby realizing squeeze and excitation processing.

Specifically, after attention pooling processing and squeeze and excitation processing, a convolution operation and a pooling operation may be performed on the token information to reduce the number of the token information. In the process of convolutional pooling, the number of convolution operations and the number of pooling operations and the order of execution are not defined here. For example, one convolution operation and one pooling operation may be used to downsample the token information and reduce the number of tokens in the token information.

Optionally, the inputting the second driving-related data in the driving-related data into the target driving correction model pre-created by the first chip to obtain the corresponding driving correction information further includes:

calling the first chip to generate candidate inference tokens of the token information according to a preset speculative sampling model, and generating the driving correction information based on the target driving decision model according to the candidate inference token and the token information.

The preset speculative sampling model may be a pre-trained model. The preset speculative sampling model may assist a language model for inference about image token information. The preset speculative sampling model may have the same or similar model structure as the language model. In some embodiments of the present disclosure, the preset speculative sampling model may be composed of hidden layers of the language model. The preset speculative sampling model may be trained and generated together with the language model. The preset speculative sampling model may include, but is not limited to: a Self-Speculative Decoding model, a REST model, an EAGLE model, etc. The candidate inference tokens may be used to assist the language model in inferring information. The candidate inference tokens may include tokens inferred and generated based on the image token information or a hidden layer feature inferred and generated based on hidden layer features of the image token information. This hidden layer feature may be an inference token predicted by the language model. The language model may be a model that processes natural language processing, including, but not limited to, a Qwen model, a MiniCPM model, a Gemma model, a MobileLLaMA model, etc.

In this embodiment of the present disclosure, the generated image token information may be input into the preset speculative sampling model and the language model of the preset multi-modal model, respectively. The preset speculative sampling model may generate candidate inference tokens based on the image token information. The preset multi-modal model may process the candidate inference tokens and image token information to generate the image token information. The process of the preset multi-modal model processing the candidate inference tokens and image token information may include: inputting the image token information and candidate inference tokens into the language model of the preset multi-modal model for once forward propagation; verifying the candidate inference tokens by a propagation result; if a token in the same position in the propagation result is the same as a token in the same position in the candidate inference token, receiving the candidate inference token as driving correction information; and correcting a difference part between the candidate inference token and the propagation result by using the language model of the preset multi-modal model, and taking the corrected token as the driving correction information.

Based on the above embodiment of the present disclosure, the calling the first chip to generate the candidate inference tokens of the token information according to the preset speculative sampling model, and generating the driving correction information based on the target driving decision model according to the candidate inference tokens and the token information include the following steps.

At step 3401, the token information is input into the target driving decision model of the first chip for inference, and second hidden layer features of the second hidden layer in the target driving decision model are extracted.

At step 3402, the preset speculative sampling model is constructed on the first chip according to the second hidden layer features, and the preset speculative sampling model is called to generate the candidate inference tokens according to the token information.

At step 3403, first hidden layer features of the preset speculative sampling model are extracted.

At step 3404, the preset speculative sampling model is updated according to the first hidden layer features, and the preset speculative sampling model is recalled to perform inference according to the candidate inference tokens to generate new candidate inference tokens.

At step 3405, updating and calling processes of the preset speculative sampling model are repeated to acquire at least two candidate inference tokens to form an inference token sequence.

At step 3406, the inference token sequence is input into the target driving decision model of the first chip for verification, and the candidate inference token in the inference token sequence that has been successfully verified is taken as the driving correction information.

The second hidden layer features may be the hidden layer features generated by processing the image token information with the language model, and the hidden layer features may be feature information generated by nonlinear transform of the image token information. The first hidden layer features may be feature parameters of the hidden layers in the preset speculative sampling model, and the first hidden layer features may be generated by nonlinear transform of the image token information by the preset speculative sampling model.

In this embodiment of the present disclosure, the image token information may be input into the language model for processing, and the hidden layers in the language model may be extracted to process the image token information to generate second hidden layer features. The preset speculative sampling model may be a model composed of the hidden layers in the language model. The parameters of the preset speculative sampling model may be updated based on the second hidden layer features. The image token information may be processed based on the preset speculative sampling model updated on the basis of the second hidden layer features. The preset speculative sampling model may be acquired to generate the candidate inference tokens.

When the preset speculative sampling model generates the candidate inference tokens, the preset speculative sampling model may be extracted to perform nonlinear transform of the input information, and the data generated by the transform may be taken as the first hidden layer features. The preset speculative sampling model may be updated by using the first hidden layer features. The preset speculative sampling model is recalled to process the candidate inference tokens generated by the above steps as input. New candidate inference tokens may be generated by the preset speculative sampling model.

Specifically, step 3403 to step 3404 may be executed cyclically, such that the update of the preset speculative sampling model and the repeated implementation of the calling process can be realized. The candidate inference tokens generated by the preset speculative sampling model each time may be extracted, and the respective candidate inference tokens may be merged into an inference token sequence. It may be understood that the inference token sequence may be implemented in a tree structure or a heap structure, and the candidate inference tokens generated by calling of the preset speculative sampling model for different times may be stored in different positions in the tree structure or heap structure, so that the language model can verify the candidate inference tokens in the inference token sequence in order.

In this embodiment of the present disclosure, the inference token sequence may be input into the language model for verification. The verification process may include the fact that the language model generates a token verification sequence corresponding to the inference token sequence. The candidate inference tokens in the inference token sequence in corresponding positions are compared according to the token verification sequence; if they are the same, it is determined that the candidate inference token is verified successfully, or this inference token and the inference token after this inference token in the inference token sequence are determined to be verification failure, and then the candidate inference token that has been verified successfully may be used as the output result of the language model.

Based on the above embodiment of the present disclosure, the target driving correction model includes at least a visual model and a language model; a resolution of the visual model is inversely proportional to a parameter scale of the language model; the resolution is at least greater than a second threshold; and the parameter scale is at least less than a first threshold.

Specifically, constituent units in the target driving correction model configured in the first chip may be divided into visual models and language models according to types. The target driving correction model is limited by hardware performances, and there is an inverse relationship between the performances of the visual model and the performances of the language model. Within performance limits of the first chip, the higher the resolution of the visual model, the better, and the smaller the parameter scale of the language model, the better. The resolution of the visual model is at least greater than a second threshold, while the parameter scale of the language model is at least less than a first threshold. The value ranges of the second threshold of different in-vehicle chips may be different. For example, an ORINx chip may be used as the first chip, and its corresponding second threshold may include 384*960, 384*384, etc. Similarly, the first threshold may be a value of a maximum scale parameter of the language model, and the first threshold may include 7B, 4B, 2.4B, 1.8B, etc.

Based on the above embodiment of the present disclosure, the target driving decision model of the target driving correction model is configured with at least one Medusa head. The generating the driving correction information based on the target driving decision model according to the candidate inference tokens and the token information further includes:

comparing an output head of the target driving decision model and a result token of each Medusa head; selecting an optimal output token in each result token; and generating the driving correction information according to the optimal output token.

The Medusa head may be an additional decoding head in the language model. The Medusa head may be trained together with the target driving correction model. The number of Medusa heads may be configured according to a business implementation scene of the target driving correction model. The output token may be a result token which is generated by decoding the output head of the target driving correction model and the Medusa head respectively. The result token may be inferred and generated by the language model based on the token information. The optimal output token may be the best one among the result tokens at the same time. The optimal output token may be determined by comparing output probabilities of the result tokens.

In this embodiment of the present disclosure, one or more Medusa heads may be configured within the target driving correction model. The result tokens may be generated by inference from the Medusa head together with the output head of the target driving correction model according to the token information. The optimal output token may be determined by comparing the result tokens outputted at the same time. The optimal output token may be outputted as the driving correction information of the target driving correction model. Further, it may be understood that the number of optimal output token may be one or more.

FIG. 13 is a schematic flowchart of a method for correcting a target driving correction model provided by Embodiment 5 of the present disclosure. Referring to FIG. 13, in this embodiment of the present disclosure, a video frame may be input into the video model for feature extraction. The generated image frame features may be fused for temporal features with historical frame features stored in the MemoryBank, specifically, fused by means of Pooling, Conv, or CrossAtttention. In addition, based on the pooling means, a SENet structure may also be added to perform weighted fusion of multiple temporal frames, thereby further improving the performances. The image tokens generated by fusion may be squeezed to reduce the number of tokens.

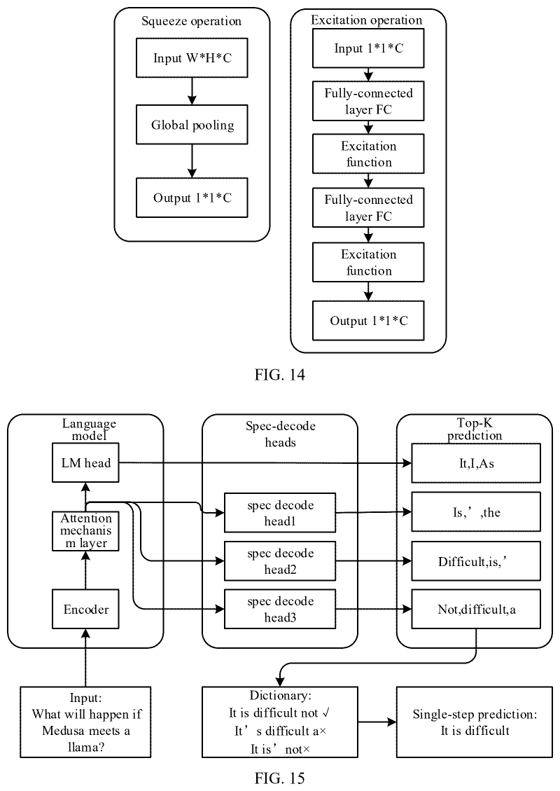

Specifically, the image tokens may be processed by a CDPNet structure. The CDPnet structure may be specifically a network structure of squeeze and excitation processing. Referring to FIG. 14, the squeeze and excitation processing may include a squeeze operation and an excitation operation. The squeeze operation may squeeze a dimension of the input image token information. The squeeze process may be achieved by Global pooling. The excitation operation may predict image tokens in a squeeze dimension generated by the squeeze process by a fully connected layer and an activation function. The importance of each channel is determined, and then excited to a channel corresponding to the image token information, thereby reducing the number of image tokens under the premise of ensuring performances.

Furthermore, prompt information may be input in this embodiment of the present disclosure. The prompt information may include relevant descriptions of a token format and a token output. After the prompt information is encoded, the encoded prompt information may be merged with the squeezed image token, and the merged image token may be input into the language model for inference, thereby generating the corresponding verification of the token.

The language model provided by the embodiment of the present disclosure may be configured with a plurality of Spec-decode heads and Lmhead of the language model to generate prediction results together, and an optimal prediction result may be selected from the plurality of prediction results by Top1, verified and then outputted as a result. Referring to FIG. 15, the Spec-decode head may be fused with the original LM head of the language model, and may be trained together with the LM head and the language model. In the training process, the language model may be kept in a frozen state without increasing the complexity involved in a service system, and may be used in conjunction with a tree-like attention mechanism to verify multiple candidate items generated by the Spec-decode head in parallel, which can improve the prediction speed of the model. Specifically, Medusa introduces a plurality of heads over a finally hidden state of the LLM, such that a plurality of subsequent tokens can be predicted in parallel. Further, the data used in the training process in this embodiment of the present disclosure may be sampled in a variety of ways, so that the model is trained by a variety of positive and negative samples of different difficulty and proportions. For a positive scene: a positive interval is searched from the last frame of the video frame, and then a left boundary of the interval is moved randomly to the left for a certain length of time according to a random probability of 0.2. For a similar negative scene: the largest similar negative sample interval may be found in a scene-free region, and randomly expanded to the left and right for a certain length of time. No label: when a positive sample interval cannot be found in the video, a sampling interval is kept [0,−1], otherwise the positive sample interval is found forward from the last frame, and then random sampling is performed in this interval by using the frame.

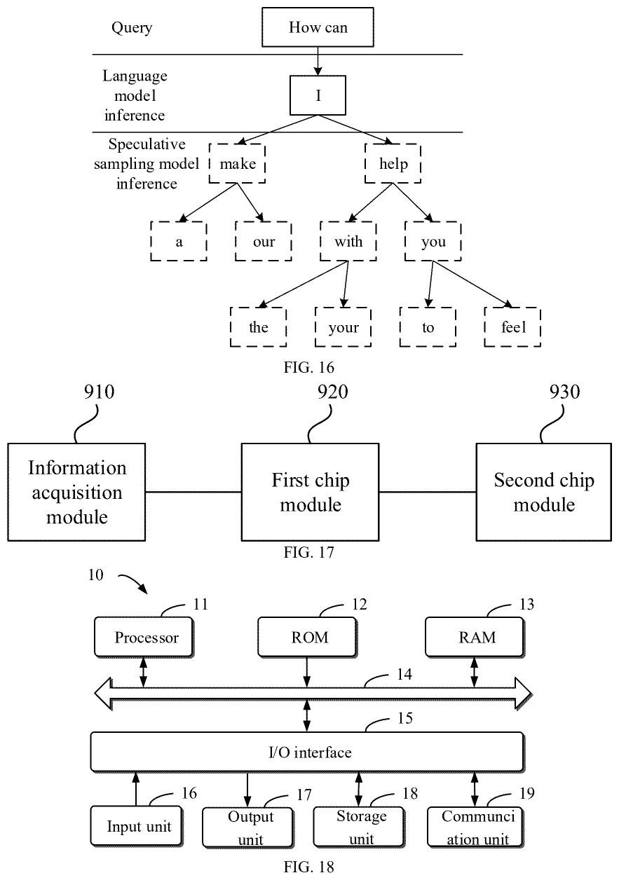

Further, the language model provided by this embodiment of the present disclosure may be accelerated in the inference process by speculative adoption. Speculative sampling may be done using Eagle speculative sampling. Referring to FIG. 16, the language model is used for inference based on an input query token. The hidden layer features in the inference process and the hidden layers in the language model are taken as the speculative sampling model, multiple rounds of inference are performed based on the inference result tokens of the language model by the speculative sampling model, and the candidate tokens are saved in a tree structure. This prediction acceleration method may be used in conjunction with the Spec-decode head to further improve the inference efficiency of the language model.

FIG. 17 is a schematic structural diagram of an apparatus for generating a trajectory provided by an embodiment of the present disclosure. The apparatus for generating the trajectory in this embodiment is integrated in a trajectory generation chip set. As shown in FIG. 17, the apparatus includes an information acquisition module 910, a first chip module 920, and a second chip module 930.

The information acquisition module 910 is configured to acquire driving-related data corresponding to a current vehicle.

The first chip module 920 is configured to input second driving-related data in the driving-related data into a target driving correction model pre-created by a first chip to obtain corresponding driving correction information.

The second chip module 930 is configured to input first driving-related data in the driving-related data into a target trajectory generation model pre-created by a second chip to obtain a candidate driving trajectory corresponding to the current vehicle; and correct the candidate driving trajectory by the second chip based on the driving correction information to obtain a corresponding target driving trajectory.

According to the embodiment of the present disclosure, the second driving-related data and the first driving-related data of the current vehicle in the driving process are acquired by the information acquisition module, and the first chip module inputs the second driving-related data into the target driving correction model pre-created by the first chip to obtain the corresponding driving correction information; the second chip module inputs the first driving-related data into the target trajectory generation model of the second chip to obtain a corresponding candidate driving trajectory; and the second chip is controlled to automatically correct the pre-generated candidate driving trajectory by the driving correction information to obtain the corresponding target driving trajectory. Therefore, the problem of poor correction effect caused by the use of manual correction for the driving trajectory in the prior art is effectively avoided, and the accuracy and effectiveness of driving trajectory correction are improved.

In some embodiments, the target driving correction model includes at least a multi-modal model; the target driving correction model includes a target streaming encoder, a target navigation encoder, a target modal alignment module and a target driving decision model; the second driving-related data includes environment perception information, navigation planning information and driving prompt information; and the first chip module 930 includes:
an image token unit, configured to input the environment perception information into the target streaming encoder of the first chip to obtain corresponding image token information;
a navigation token unit, configured to input the navigation planning information into the target navigation encoder of the first chip to obtain corresponding navigation token information;
a data alignment unit, configured to input the image token information and the navigation token information into the target modal alignment module of the first chip as driving token information to obtain mapped multi-modal features; and
a correction information unit, configured to input prompt text features corresponding to the driving prompt information and the multi-modal features into the target driving decision model of the first chip to obtain corresponding driving correction information.

In some embodiments, the first chip module 930 further includes: a token squeeze unit configured to perform squeeze processing on token information of the second driving-related data on the first chip to reduce a data amount of the token information.

In other embodiments, the token squeeze unit is specifically configured to: call the first chip to perform attention pooling processing and squeeze and excitation processing on the token information in sequence; call the first chip to perform conventional pooling processing on the processed token information; and take the processed token information as new token information.

In some embodiments, the first chip module 930 further includes: an inference acceleration unit, configured to call the first chip to generate candidate inference tokens of the token information according to a preset speculative sampling model, and generate the driving correction information based on the target driving decision model according to the candidate inference tokens and the token information.

In some embodiments, the inference acceleration unit is specifically configured to: input the token information into the target driving decision model of the first chip for inference, and extract second hidden layer features in a hidden layer in the target driving decision model;
construct the preset speculative sampling model on the first chip according to the second hidden layer features, and call the preset speculative sampling model to generate the candidate inference tokens according to the token information;
extract first hidden layer features of the preset speculative sampling model;
update the preset speculative sampling model according to the first hidden layer features, and recall the preset speculative sampling model to perform inference according to the candidate inference tokens to generate new candidate inference tokens;
repeat updating and calling processes of the preset speculative sampling model to acquire at least two candidate inference tokens to form an inference token sequence; and
input the inference token sequence into the target driving decision model of the first chip for verification, and take the candidate inference token in the inference token sequence that has been successfully verified as the driving correction information.

In some embodiments, the target driving correction model includes at least a visual model and a language model; a resolution of the visual model is inversely proportional to a parameter scale of the language model; the resolution is at least greater than a second threshold; and the parameter scale is at least less than a first threshold.

In some embodiments, the target driving decision module of the target driving correction model is configured with at least one Medusa head. The first chip module 930 is further configured to compare an output head of the target driving decision model and a result token of each Medusa head; select an optimal output token from the result tokens; and generate the driving correction information according to the optimal output token.

In some embodiments, the first driving-related data includes sensor information and navigation planning information. The sensor information includes environment perception information and state information. The target trajectory generation model includes a target backbone network, a target encoder, a target decoder and a target memory module. The target memory module is configured to store BEV features in a time dimension and a spatial dimension. The second chip module 920 is specifically configured to:
input the environment perception information into the target backbone network of the second chip to obtain target fusion features, and project the target fusion features into a BEV space;
determine target BEV features according to the target fusion features projected into the BEV space and the BEV features output by the target memory module of the second chip, and update the BEV features stored in the target memory module according to the target BEV features;
input the state information and the navigation planning information into the target encoder of the second chip to obtain target encoding features; and
input the target encoding features and the target BEV features into the target decoder of the second chip to obtain the candidate driving trajectory corresponding to the current vehicle.

The apparatus for generating the trajectory provided by the embodiment of the present disclosure may execute the method for generating the trajectory provided by any embodiment of the present disclosure, and has corresponding functional modules and beneficial effects of an execution method.

In one embodiment, FIG. 18 is a schematic structural diagram of an electronic device provided by an embodiment of the present disclosure. As shown in FIG. 18, a schematic structural diagram of an electronic device 10 for implementing an embodiment of the present disclosure may be shown. The electronic device is intended to represent various forms of digital computers, such as laptops, desktop computers, workbenches, personal digital assistants, servers, blade servers, mainframe computers, and other appropriate computers. The electronic device may also represent various forms of mobile devices, such as personal digital assistants, cellular phones, smart phones, wearable devices (e.g., helmets, glasses, and watches) and other similar computing apparatuses. The components shown herein, their connections and relationships, and their functions are for example only and are not intended to limit the implementation of the present disclosure described and/or required herein.

As shown in FIG. 18, the electronic device 10 includes at least one processor 11, and a memory that is in communicative connection with at least one processor 11, such as a read-only memory (ROM) 12, a random access memory (RAM) 13 and the like. The memory stores computer programs that can be executed by at least one processor. The processor 11 may perform various appropriate actions and processes according to computer programs stored in the ROM 12 or computer programs loaded from a storage unit 18 into the RAM 13. The RAM 13 is further configured to store various programs and data required for the operations of the electronic device 10. The processor 11, the ROM 12 and the RAM 13 are connected to each other via a bus 14. The input/output (I/O) interface 15 is also connected to the bus 14.

A plurality of components in the electronic device 10 are connected to an I/O interface 15, including: an input unit 16, such as a keyboard or a mouse; an output unit 17, such as various types of displays, or speakers; a storage unit 18, such as a disk or an optical disc; and a communication unit 19, such as a network card, a modem, or a wireless communication transceiver. The communication unit 19 allows the electronic device 10 to exchange information/data with other devices by a computer network such as the Internet and/or various telecommunications networks.

The processor 11 may be a variety of general-purpose and/or special-purpose processing components with processing and computing capabilities. Some examples of the processor 11 include, but are not limited to, a central processing unit (CPU), a graphics processing unit (GPU), various special-purpose artificial intelligence (AI) computing chips, various processors running machine learning model algorithms, a digital signal processor (DSP), and any appropriate processors, controllers, microcontrollers, etc. The processor 11 performs various methods and processes described above, such as the method for generating the trajectory.

In some embodiments, the method for generating the trajectory may be implemented as a computer program, which is tangibly contained in a computer-readable storage medium, such as the storage unit 18. In some embodiments, part or all of the computer programs may be loaded and/or installed onto the electronic device 10 via ROM 12 and/or the communication unit 19. When the computer program is loaded into RAM 13 and executed by the processor 11, one or more steps of the method for generating the trajectory described above can be performed. Alternatively, in other embodiments, the processor 11 may be configured to perform the method for generating the trajectory by any other appropriate means (e.g., with the help of firmware).

Various embodiments of the systems and technologies described above may be implemented in digital electronic circuit systems, integrated circuit systems, field-programmable gate arrays (FPGAs), application-specific integrated circuits (ASICs), application-specific standards products (ASSPs), system-on-chips (SOCs), complex programmable logic devices (CPLDs), computer hardware, firmware, software, and/or a combination thereof. These various embodiments may include: the implementation in one or more computer programs. The one or more computer programs may be executed and/or interpreted on a programmable system that includes at least one programmable processor. The programmable processor may be a special-purpose or general-purpose programmable processor that may receive data and instructions from the storage system, at least one input apparatus, and at least one output apparatus, and transmit the data and instructions to the storage system, at least one input apparatus, and at least one output apparatus.

The computer programs used to implement the method of the present disclosure may be compiled in any combination of one or more programming languages. These computer programs may be provided to a generate-purpose computer, a special-purpose computer or processors of other programmable data processing apparatuses, such that the computer programs, when executed by the processor, enables functions/operations specified in the flowcharts and/or block diagrams to be implemented. The computer programs may be executed entirely on a machine, partly on a machine, partially on a machine as a stand-alone software package, partly on a remote machine, or entirely on a remote computer or a server.

In the context of the present disclosure, a machine-readable storage medium may be a tangible medium which may include or store instructions for use by or in combination with an instruction execution system, apparatus or device. The machine-readable storage medium may include, but is not limited to, electronic, magnetic, optical, electromagnetic, infrared, or semiconductor systems, apparatuses or devices, or any combination thereof. Alternatively, the computer-readable storage medium may be a machine-readable signal medium. More specific examples of the machine-readable storage medium may include: an electric connector having one or more leads, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof.

The systems and technologies described here may be implemented in a computing system (e.g., as a data server) that includes a back-end component, or a computing system (e.g., an application server) that includes middleware components, or a computing system (e.g., a user computer with a graphical user interface or a web browser by which the user can interact with the implementation of the systems and technologies described herein) that includes a front-end component, or a computing system that includes any combination of such back-end component, middleware component, or front-end component. The components of a system may be connected to each other by means of digital data communication in any form or medium (e.g., a communication network). Examples of the communication network include: a local area network (LAN), a wide area network (WAN), a blockchain network, and the Internet.

A computing system may include a client and a server. The client and the server are generally away from each other and usually interact over the communication network. A relationship between the client and the server is created by computer programs that run on the corresponding computer and have a client-server relationship with each other. The server may be a cloud server, also known as a cloud computing server or cloud host, which is a host product in the cloud computing service system, which solves the defects of difficult management and weak business scalability in traditional physical hosting and VPS services.

An embodiment of the present application further provides a computer program product. The computer program product includes computer programs, wherein the computer programs, when executed by a processor, may implement the method for generating the trajectory provided by any embodiment of the present application.

During the implementation of the computer program product, one or more programming languages or a combination thereof may be used to compile computer program codes for performing the operations of the present disclosure, wherein the programming languages include, but are not limited to, object-oriented programming languages, such as Java, Smalltalk and C++, and conventional procedural programming languages, such as the “C” language or similar programming languages. The program codes may be executed entirely on a user computer, partly on a user computer, as a stand-alone software package, partly on the user computer and partly on a remote computer, or entirely on a remote computer or a server. In a case of the remote computer, the remote computer may be connected to the user computer through any type of network (including a local area network (LAN) or wide area network (WAN)), or may be connected to an external computer (e.g., using an Internet service provider via the Internet).

It should be understood that steps can be reordered, added, or deleted by using various forms of processes shown above. For example, the steps described in the present disclosure may be executed in parallel, sequentially, or in different sequences, which will not be limited herein as long as the desired results of the technical solutions of the present disclosure can be achieved.

The above are specific implementations, but do not constitute any limitation on the protection scope of the present disclosure. A person skilled in the art should understand that various modifications, combinations, subcombinations, and substitutions can be made according to the design requirements and other factors. Any modification, equivalent replacement, improvement and so on made within the spirit and principle of the present disclosure shall be encompassed by the protection scope of the present disclosure.

1. A method for generating a trajectory, comprising:
acquiring driving-related data corresponding to a current vehicle;
inputting first driving-related data in the driving-related data into a pre-created target trajectory generation model to obtain a candidate driving trajectory corresponding to the current vehicle;
inputting second driving-related data in the driving-related data into a pre-created target driving correction model to obtain corresponding driving correction information; and
correcting the candidate driving trajectory based on the driving correction information to obtain a corresponding target driving trajectory, such that the current vehicle automatically drives according to the target driving trajectory.

2. The method according to claim 1, wherein the first driving-related data comprises sensor information and navigation planning information; the sensor information comprises environment perception information and state information; the target trajectory generation model comprises a target backbone network, a target encoder, a target decoder and a target memory module; the target memory module is configured to store BEV features in a time dimension and a spatial dimension; and
the inputting first driving-related data in the driving-related data into a pre-created target trajectory generation model to obtain a candidate driving trajectory corresponding to the current vehicle comprises:
inputting the environment perception information into the target backbone network to obtain target fusion features, and projecting the target fusion features into a BEV space;
determining target BEV features according to the target fusion features projected into the BEV space and BEV features output by the target memory module, and updating the BEV features stored in the target memory module according to the target BEV features;
inputting the state information and the navigation planning information into the target encoder to obtain target encoding features; and
inputting the target encoding features and the target BEV features into the target decoder to obtain the candidate driving trajectory corresponding to the current vehicle.

3. The method according to claim 1, wherein a process of training the target trajectory generation model comprises:
acquiring a perception sample set, a regulatory control sample set and an initial trajectory generation model;
iteratively training parameters of the initial trajectory generation model based on the perception sample set, and determining a trained initial trajectory generation model as a first model;
iteratively training parameters of the first model based on the regulatory control sample set, and determining a trained first model as a second model; and
iteratively training parameters of the second model based on the perception sample set and the regulatory control sample set, and determining a trained second model as the target trajectory generation model.

4. The method according to claim 3, wherein the perception sample set comprises a plurality of driving-related samples, and an obstacle label and a road structure label carried by each driving-related sample; and
the iteratively training parameters of the initial trajectory generation model based on the perception sample set, and determining a trained initial trajectory generation model as a first model comprise:
inputting the driving-related samples in the perception sample set into the initial trajectory generation model to obtain first predicted obstacle information and a first predicted road structure; and
training parameters of the initial trajectory generation model according to a difference between the first predicted obstacle information and the obstacle label, and a difference between the first predicted road structure and the road structure label, and determining a trained initial trajectory generation model as the first model.

5. The method according to claim 4, wherein the regulatory control sample set comprises a plurality of driving-related samples and a trajectory at a next moment corresponding to each driving-related sample; and
the iteratively training parameters of the first model based on the regulatory control sample set, and determining a trained first model as a second model comprise:
inputting the driving-related samples in the regulatory control sample set into the first model to obtain a first predicted trajectory; and
training the parameters of the first model according to a difference between the first predicted trajectory and the trajectory at the next moment, and determining the trained first model as the second model.

6. The method according to claim 5, wherein the iteratively training parameters of the second model based on the perception sample set and the regulatory control sample set, and determining the trained second model as the target trajectory generation model comprise:
generating a fusion sample set according to the perception sample set and the regulatory control sample set, wherein the fusion sample set comprises a plurality of driving-related samples, and an obstacle label, a road structure label and a trajectory at a next moment corresponding to each driving-related sample;
inputting the driving-related samples in the fusion sample set into the second model to obtain a second predicted obstacle, a second predicted road structure and a second predicted trajectory; and
training the parameters of the second model according to a difference between the second predicted obstacle and the obstacle label, a difference between the second predicted road structure and the road structure label, and a difference between the second predicted trajectory and the trajectory at the next moment, and determining the trained second model as the target trajectory generation model.

7. The method according to claim 3, wherein the driving-related samples comprise sensor samples and navigation planning samples; the sensor data samples comprise environment perception samples and state samples; and the environment perception samples comprises frame samples and point cloud samples.

8. The method according to claim 7, wherein the initial trajectory generation model comprises an initial backbone network, an initial encoder, an initial decoder and a target memory module; and
the inputting the driving-related samples in the perception sample set into the initial trajectory generation model to obtain first predicted obstacle information and a first predicted road structure comprises:
initializing the initial decoder based on a preset instance;
inputting the environment perception samples into the initial backbone network to obtain first fusion features, and projecting the first fusion features into a BEV space;
determining first BEV features according to the first fusion features projected into the BEV space and the BEV features output by the target memory module, and updating the BEV features stored in the target memory module according to the first BEV features;
inputting the state samples and the navigation planning samples into the initial encoder to obtain first encoding features; and
inputting the first encoding features and the first BEV features into the initialized initial decoder to obtain the first predicted obstacle information and the first predicted road structure.

9. The method according to claim 1, wherein the inputting first driving-related data in the driving-related data into a pre-created target trajectory generation model to obtain a candidate driving trajectory corresponding to the current vehicle comprises:
inputting the first driving-related data into the pre-created target trajectory generation model to obtain the candidate driving trajectory, obstacle information and a road structure corresponding to the current vehicle.

10. A method for generating a trajectory, which is applied to a trajectory generation chip set, wherein the chip set at least comprises a first chip and a second chip; and the method comprises:
acquiring driving-related data corresponding to a current vehicle;
inputting second driving-related data in the driving-related data into a target driving correction model pre-created by the first chip to obtain corresponding driving correction information; and
inputting first driving-related data in the driving-related data into a target trajectory generation model pre-created by the second chip to obtain a candidate driving trajectory corresponding to the current vehicle; and correcting the candidate driving trajectory by the second chip based on the driving correction information to obtain a corresponding target driving trajectory, such that the current vehicle automatically drives according to the target driving trajectory.

11. The method according to claim 10, wherein the target driving correction model comprises at least a multi-modal model; the target driving correction model comprises a target streaming encoder, a target navigation encoder, a target modal alignment module and a target driving decision model; the second driving-related data comprises environment perception information, navigation planning information and driving prompt information; and the inputting second driving-related data in the driving-related data into a target driving correction model pre-created by the first chip to obtain corresponding driving correction information comprises:
inputting the environment perception information into the target streaming encoder of the first chip to obtain corresponding image token information;
inputting the navigation planning information into the target navigation encoder of the first chip to obtain corresponding navigation token information;
inputting the image token information and the navigation token information into the target modal alignment module of the first chip as driving token information to obtain mapped multi-modal features; and
inputting prompt text features corresponding to the driving prompt information and the multi-modal features into the target driving decision model of the first chip to obtain corresponding driving correction information.

12. The method according to claim 11, wherein the inputting second driving-related data in the driving-related data into a target driving correction model pre-created by the first chip to obtain corresponding driving correction information further comprises:
squeezing token information of the second driving-related data on the first chip to reduce a data amount of the token information.

13. The method according to claim 12, wherein the squeezing token information of the second driving-related data on the first chip comprises:
calling the first chip to perform attention pooling processing and squeeze and excitation processing on the token information in sequence; and
calling the first chip to perform convolutional pooling processing on the processed token information, and taking the processed token information as the new token information.

14. The method according to claim 11, wherein the inputting second driving-related data in the driving-related data into a target driving correction model pre-created by the first chip to obtain corresponding driving correction information further comprises:
calling the first chip to generate candidate inference tokens of the token information according to a preset speculative sampling model, and generating the driving correction information based on the target driving decision model according to the candidate inference tokens and the token information.

15. The method according to claim 14, wherein the calling the first chip to generate candidate inference tokens of the token information according to a preset speculative sampling model, and generating the driving correction information based on the target driving decision model according to the candidate inference tokens and the token information comprise:
inputting the token information into the target driving decision model of the first chip for inference, and extracting second hidden layer features in a hidden layer in the target driving decision model;
constructing the preset speculative sampling model on the first chip according to the second hidden layer features, and calling the preset speculative sampling model to generate the candidate inference tokens according to the token information;
extracting first hidden layer features of the preset speculative sampling model;
updating the preset speculative sampling model according to the first hidden layer features, and recalling the preset speculative sampling model to perform inference according to the candidate inference tokens to generate new candidate inference tokens;
repeating updating and calling processes of the preset speculative sampling model to acquire at least two candidate inference tokens to form an inference token sequence; and
inputting the inference token sequence into the target driving decision model of the first chip for verification, and taking the candidate inference token in the inference token sequence that has been successfully verified as the driving correction information.

16. The method according to claim 11, wherein the target driving correction model comprises at least a visual model and a language model; a resolution of the visual model is inversely proportional to a parameter scale of the language model; the resolution is at least greater than a second threshold; and the parameter scale is at least less than a first threshold.

17. The method according to claim 14, wherein the target driving decision model of the target driving correction model is configured with at least one Medusa head; and the generating the driving correction information based on the target driving decision model according to the candidate inference tokens and the token information further comprise:
comparing an output head of the target driving decision model and a result token of each Medusa head; and
selecting an optimal output token from the result tokens, and generating the driving correction information according to the optimal output token.

18. The method according to claim 10, wherein the first driving-related data comprises sensor information and navigation planning information; the sensor information comprises environment perception information and state information; the target trajectory generation model comprises a target backbone network, a target encoder, a target decoder and a target memory module; the target memory module is configured to store BEV features in a time dimension and a spatial dimension; and
the inputting first driving-related data in the driving-related data to the target trajectory generation model pre-created by the second chip to obtain a candidate driving trajectory corresponding to the current vehicle comprises:
inputting the environment perception information into the target backbone network of the second chip to obtain target fusion features, and projecting the target fusion features into a BEV space;
determining target BEV features according to the target fusion features projected into the BEV space and BEV feature output by the target memory module of the second chip, and updating the BEV features stored in the target memory module according to the target BEV features;
inputting the state information and the navigation planning information into the target encoder of the second chip to obtain target encoding features; and
inputting the target encoding features and the target BEV features into the target decoder of the second chip to obtain the candidate driving trajectory corresponding to the current vehicle.

19. An electronic device, comprising:
at least one processor; and
a memory communicationally connected to the at least one processor; wherein,
the memory stores a computer program executable by the at least one processor, and the computer program is executed by the at least one processor to enable the at least one processor to execute the method for generating a trajectory according to claim 1.

20. The non-transitory computer-readable storage medium, configured to store computer instructions therein, the computer instructions being configured to, when being executed by a processor, implement the method for generating the trajectory according to claim 1.
